(19) United States
(12) Patent Application Publication
(10) Pub. No.: US 2026/0189316 A1
(43) Pub. Date: Jul. 2, 2026

(54) COMMUNICATION SYSTEM AND COMMUNICATION APPARATUS

(71) Applicant: 1FINITY Inc., Kawasaki-shi Kanagawa (JP)

(72) Inventor: SHIGEAKI KAWAMATA, Sagamihara (JP)

(73) Assignee: 1FINITY Inc., Kawasaki-shi Kanagawa (JP)

(21) Appl. No.: 19/546,676

(22) Filed: Feb. 23, 2026

Related U.S. Application Data
(63) Continuation of application No. PCT/JP2023/030487, filed on Aug. 24, 2023.

(51) Int. Cl. H04J 3/06; H04L 9/40

(52) U.S. Cl. CPC H04J 3/0667; H04L 63/0428

(57) ABSTRACT

A communication system includes: a first communication apparatus, and a second communication apparatus that performs a synchronization process for establishing synchronization with the first communication apparatus, wherein the first communication apparatus is configured to start a first timer with a first process, and the second communication apparatus is configured to start a second timer with a second process including decryption on a first signal, and enable control for obtaining second time-point information in response to expiration of the second timer, and a time of the first timer corresponds to a first time longer than a time taken for a process for encryption in the first communication apparatus, and a time of the second timer corresponds to a second time longer than a time taken for a process for the decryption in the second communication apparatus.

### CROSS-REFERENCE TO RELATED APPLICATION

This application is a continuation application of International Application PCT/JP2023/030487 filed on Aug. 24, 2023 and designated the U.S., the entire contents of which are incorporated herein by reference.

### FIELD

The present embodiment relates to a communication system and a communication apparatus.

### BACKGROUND

As one of communication schemes, there is a time division duplex (TDD) scheme. The TDD scheme is, for example, a scheme in which radio resources in a communication direction (downstream direction) from a base station device to a terminal device and a communication direction (upstream direction) from the terminal device to the base station device are used in a time division manner. Therefore, a radio frame output timing at an antenna end of the base station device may be caused to coincide among a plurality of base station devices, or transmission and reception timings may be caused to coincide among the plurality of base station devices. In this case, a reference clock, a reference timing, and the like used in the base station device are synchronized with high precision among a plurality of base station devices or among a plurality of communication apparatuses constituting the base station device. Increasing the precision of a synchronization system between the communication apparatuses leads to increasing the reliability in communication.

Further, in IEEE Standards Association that is a standard organization of Institute of Electrical and Electronics Engineers (IEEE), a synchronization system in communication is discussed.

In the synchronization system, for example, a master communication apparatus communicates with a slave communication apparatus based on a global positioning system (GPS) or the like, thereby synchronizing time points between the communication apparatuses.

Currently, in IEEE Standards Association of IEEE, a system using a precision time protocol (PTP), which is an example of the synchronization system, is discussed. The PTP is, for example, a time-point synchronization protocol standardized as IEEE1588.

In the related art, matters related to security in the PTP have been at a supplementary level in the standard (Non Patent Documents 1 to 4), but in recent years, demand for security has increased, and standard definition has been studied (Non Patent Document 5).

For example, related arts are disclosed in, IEEE1588-2008 (Non Patent Document 1), ITU-T G.8275.1/Y.1369.1 (November 2022) (Non Patent Document 2), ITU-T G.8275.2/Y.1369.2 (November 2022) (Non Patent Document 3), ITU-T G.8265.1/Y.1365.1 (November 2022) (Non Patent Document 4), and IEEE1588-2019 (Non Patent Document 5).

### SUMMARY

According to an aspect of the embodiments, a communication system including: a first communication apparatus; and a second communication apparatus that performs a synchronization process for establishing synchronization with the first communication apparatus, wherein the first communication apparatus is configured to perform a first process including encryption on a first signal to which information regarding a first time point is attached, and start a first timer with the first process, and transmit an encrypted first signal in response to expiration of the first timer, the second communication apparatus is configured to receive the encrypted first signal from the first communication apparatus, and start a second timer with a second process including decryption on the first signal, enable control for obtaining second time-point information in response to expiration of the second timer, obtain information regarding a third time point, perform the first process on a second signal, and start third timer with the first process, and transmit an encrypted second signal in response to expiration of the third timer, the first communication apparatus is configured to receive the encrypted second signal from the second communication apparatus, perform the second process on the second signal, start a fourth timer with the second process, and enable control for obtaining fourth time-point information in response to expiration of the fourth timer, a time of the first timer corresponds to a first time longer than a time taken for a process for encryption in the first communication apparatus, a time of the second timer corresponds to a second time longer than a time taken for a process for the decryption in the second communication apparatus, a time of the third timer corresponds to a third time longer than a time taken for a process for the encryption in the second communication apparatus, and a time of the fourth timer corresponds to a fourth time longer than a time taken for a process for decryption in the first communication apparatus.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram illustrating an example of a communication system according to a first embodiment;

FIG. 2 is an example of a functional configuration diagram of a communication apparatus in the communication system in the first embodiment;

FIG. 3 is an example of a functional configuration diagram of a communication apparatus in the communication system in the first embodiment;

FIG. 4 is an example of a functional configuration diagram of a communication apparatus in the communication system in the first embodiment;

FIG. 5 is an example of a sequence of the communication system in the first embodiment;

FIG. 6 is an example of a flowchart of a process performed by the communication apparatus in the first embodiment when a signal is transmitted, the process including a first process including an encryption process;

FIG. 7 is a diagram illustrating an example of a flowchart of a process performed by the communication apparatus in the first embodiment when a signal is received, the process including a second process including a decryption process;

FIGS. 8A and 8B are diagrams illustrating an example of a relationship among a defined predetermined time, a time taken for the first process, and a time taken for the second process in the first embodiment;

FIG. 9 is an example of a functional configuration diagram of a communication apparatus in a communication system according to a second embodiment;

FIG. 10 is an example of a functional configuration diagram of a communication apparatus in the communication system in the second embodiment;

FIG. 11 is an example of a functional configuration diagram of a communication apparatus in the communication system in the second embodiment;

FIG. 12 is a diagram illustrating an example of a sequence of the communication system in the second embodiment;

FIG. 13 is a diagram illustrating an example of a flowchart of a process performed by the communication apparatus in the second embodiment when a signal is transmitted, the process including a first process including an encryption process;

FIG. 14 is a diagram illustrating an example of a flowchart of a process performed by the communication apparatus in the second embodiment when a signal is received, the process including a second process including a decryption process;

FIGS. 15A and 15B are diagrams illustrating an example of a relationship among a predetermined time defined for each of the first process and the second process and a time of a process on a signal, in the second embodiment;

FIG. 16 is an example of a functional configuration diagram of a communication apparatus in a communication system according to a third embodiment;

FIG. 17 is an example of a functional configuration diagram of a communication apparatus in the communication system in the third embodiment;

FIG. 18 is an example of a functional configuration diagram of a communication apparatus in the communication system in the third embodiment;

FIG. 19 is an example of a hardware configuration diagram of the communication apparatus in the communication system; and

FIG. 20 is an example of a hardware configuration diagram of the communication apparatus in the communication system.

### DESCRIPTION OF EMBODIMENTS

There is an increasing demand for security for PTP requirements discussed in IEEE.

Therefore, in IEEE, a method in which a master communication apparatus encrypts a signal after attaching a time stamp for synchronization to the signal, and a slave communication apparatus retains the time stamp after decrypting the signal is discussed.

However, there is a possibility that a processing time taken for encryption and decryption of a signal varies for each signal. Thus, when a series of PTP protocols is repeatedly performed, synchronization between the master communication apparatus and the slave communication apparatus fluctuates. Therefore, the synchronization precision decreases between the master communication apparatus and the slave communication apparatus that perform synchronization or synchronization between the master communication apparatus and the slave communication apparatus has difficulty.

Hereinafter, the present embodiment will be described in detail with reference to the drawings. Problems and embodiments in the present specification are merely examples, and do not limit the scope of rights of the present application. In particular, the technology of the present application can be applied to even different expressions as long as the expressions are technically equivalent even if the expressions are different, and the scope of rights is not limited. Each embodiment can be appropriately combined within a range in which the process contents do not contradict each other.

In addition, terms and technical contents described in the present specification may be appropriately used as terms and technical contents described in a specification or a contribution as a communication standard such as IEEE. Such specifications are described in Non Patent Documents 1 to 5, for example.

### First Embodiment

Hereinafter, embodiments of a communication apparatus and a communication system disclosed in the present application will be described in detail with reference to the drawings. Note that the following embodiments do not limit the disclosed technology.

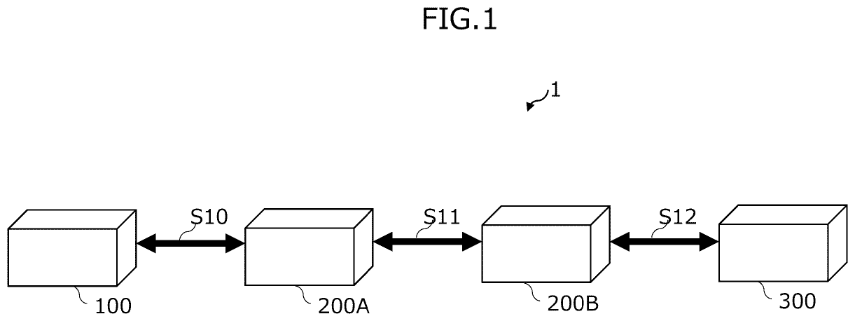

FIG. 1 illustrates a communication system 1 according to a first embodiment. The communication system 1 includes a communication apparatus 100, a communication apparatus 200A, a communication apparatus 200B, and a communication apparatus 300. Note that, in a case where the communication apparatuses 200A and 200B are not distinguished, the communication apparatuses 200A and 200B may be simply referred to as a communication apparatus 200. Note that, in FIG. 1, the communication apparatus 100 and the communication apparatus 200A communicate with each other via a communication network S10. Furthermore, the communication apparatus 200A and the communication apparatus 200B communicate with each other via a communication network S11. Furthermore, the communication apparatus 200B and the communication apparatus 300 communicate with each other via a communication network S12. Note that the communication networks S10, S11, and S12 may be configured in a wired manner or in a wireless manner. In addition, the communication networks S10, S11, and S12 may be different for each communication network between the wired manner and the wireless manner. Note that the communication apparatus 100 is, for example, a grand master clock (GMC), a centralized unit (CU), or a distributed unit (DU). Furthermore, the communication apparatus 200 is, for example, a CU, a DU, a Layer 3 router, a Layer 2 switch, or a radio unit (RU).

Note that a communication apparatus having a reference time point in a synchronization process may be referred to as a master device, and a communication apparatus that performs the synchronization process based on the time point of the master device may be referred to as a slave device. Note that the communication apparatuses 100, 200A, and 200B are examples of master communication apparatuses. Note that the communication apparatuses 200A, 200B, and 300 are examples of slave communication apparatuses. Note that, in the following description, a case where communication is performed between the communication apparatus 100 and the communication apparatus 200A will be described as an example. Note that, in this case, the communication apparatus 100 will be described as a master device, and the communication apparatus 200A will be described as a slave device. Note that, in the communication system 1, the synchronization process can be similarly performed between any two communication apparatuses.

The communication apparatus 100 obtains time-point information, for example, by using global positioning system (GPS) synchronization. The communication apparatus 200 can perform (enable performing of) the synchronization process with the communication apparatus 100 to perform frequency synchronization and time-point synchronization. Note that the communication apparatus 100 may be connected to another communication apparatus (not illustrated) using the GPS synchronization at a preceding stage, perform synchronization process with the other communication apparatus, and perform frequency synchronization and time-point synchronization.

For example, in the case of FIG. 1, the synchronization process is sequentially performed step by step, that is, the communication apparatus 200A performs a synchronization process with the communication apparatus 100, the communication apparatus 200B performs a synchronization process with the communication apparatus 200A, and thus synchronization is established between the communication apparatus 100 and the communication apparatus 200.

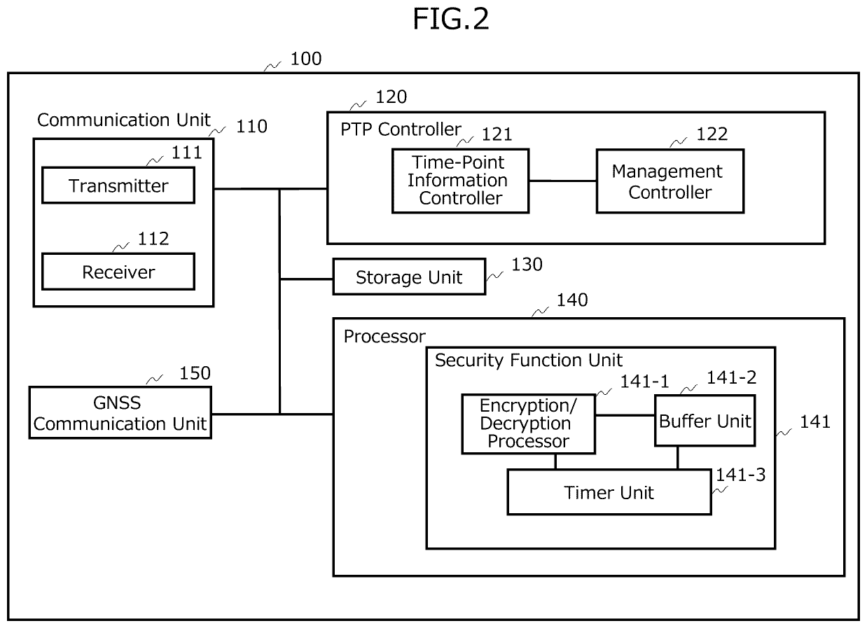

The communication apparatus 100 will be described. FIG. 2 illustrates an example of a functional configuration diagram of the communication apparatus 100. The communication apparatus 100 includes a communication unit 110, a PTP controller 120, a storage unit 130, a processor 140, and a GNSS communication unit 150. Note that the communication unit 110 includes a transmitter 111 and a receiver 112, and communicates with the communication apparatus 200. Note that the communication apparatus 100 operates as, for example, a master device.

Note that the communication apparatus 100 may include a plurality of the present components excluding the GNSS communication unit 150, and communicate with a plurality of communication apparatuses 200.

The communication unit 110 communicates with the communication apparatus 200 via the communication network S10. Note that the transmitter 111 transmits a signal directed to the communication apparatus 200 according to processing of the processor 140. Furthermore, the receiver 112 receives a signal from the communication apparatus 200, for example.

The transmitter 111 transmits, for example, a first signal to the communication apparatus 200. Note that the first signal is an example of a signal transmitted from the master device to the slave device. In addition, the first signal is, for example, an Announce Message, a Sync Message, or a Delay_Resp Message. In addition, a signal intended to obtain time-point information among first signals is referred to as a first signal of a first type. In addition, a signal that is not intended to obtain time-point information among first signals is referred to as a first signal of a second type. Note that a signal transmitted from the transmitter 111 among signals that are not used in the synchronization process is referred to as a third signal.

The receiver 112 receives, for example, a second signal from the communication apparatus 200. Note that, the second signal is an example of a signal transmitted from the slave device to the master device. Furthermore, the second signal is, for example, Delay_Req Message. In addition, a signal intended to obtain time-point information among second signals is referred to as a second signal of a first type. In addition, a signal that is not intended to obtain time-point information among second signals is referred to as a second signal of a second type. Note that a signal received by the receiver 112 among signals that are not used in the synchronization process is referred to as a fourth signal.

The PTP controller 120 performs control related to the PTP performed in the communication apparatus 100. Specifically, the PTP controller 120 can perform (enable performing of) control to obtain information regarding a time point (may be referred to as time-point information) such as a time stamp, control to attach the obtained time-point information to a signal to be transmitted, and the like.

Further, details of the PTP controller 120 will be described. The PTP controller 120 includes a time-point information controller 121 and a management controller 122. The time-point information controller 121 performs control related to time-point information, for example. Specifically, the time-point information controller 121 controls, for example, generation of time-point information, determination of whether time-point information is needed for a signal, and attachment of time-point information corresponding to the signal. The management controller 122 performs, for example, generation of a signal to be transmitted (for example, Announce Message, Sync Message, and Delay_Resp Message), control of a transmission interval, and response control to a reception signal (for example, Delay_Req Message). For example, among operations in the PTP controller 120, such as retention of information in a reception signal, control that is not performed by the time-point information controller 121 is performed. Note that the storage unit 130 may retain information in a reception signal and retain time-point information (for example, a time stamp) at the time of receiving a reception signal.

The storage unit 130 can store, for example, the second signal to be received and time-point information at the time of reception (for example, a time stamp).

The processor 140 performs an encryption process on a signal to be transmitted. Furthermore, the processor 140 performs a decryption process on the signal received by the receiver 112. Note that the processor 140 may be described separately as a first processor that performs an encryption process and a second processor that performs a decryption process.

Furthermore, details of the processor 140 will be described. The processor 140 includes a security function unit 141. The security function unit 141 includes an encryption/decryption processor 141-1, a buffer unit 141-2, and a timer unit 141-3. The encryption/decryption processor 141-1 performs an encryption process on a signal to be transmitted. Furthermore, the encryption/decryption processor 141-1 performs a decryption process on the signal received by the receiver 112. The buffer unit 141-2 can temporarily store the encrypted or decrypted signal. Furthermore, the timer unit 141-3 can measure a time by starting a timer. The timer unit 141-3 starts the timer, for example, at the time of starting the encryption process or the decryption process or at a timing before the start.

The global navigation satellite system (GNNS) communication unit 150 obtains time-point information. Note that the GNSS communication unit 150 may be referred to as a time-point information obtaining unit. The GNSS communication unit 150 includes, for example, a receiver corresponding to a global navigation satellite system (GPS), and can obtain high-precision time-point information and a synchronization clock.

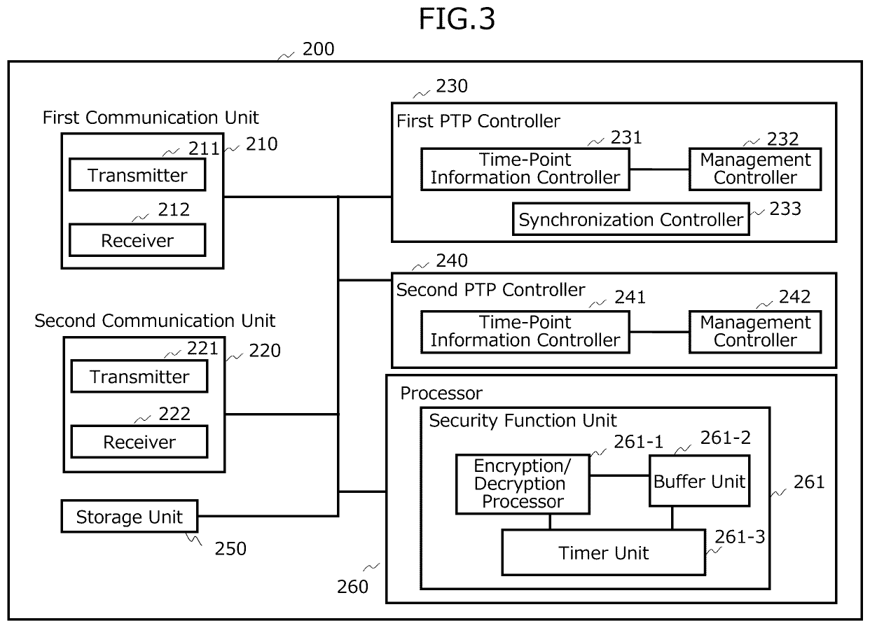

Next, the communication apparatus 200 will be described. FIG. 3 illustrates an example of a functional configuration diagram of the communication apparatus 200. The communication apparatus 200 includes a first communication unit 210, a second communication unit 220, a first PTP controller 230, a second PTP controller 240, a storage unit 250, and a processor 260. Note that the first communication unit 210 may include a transmitter 211 and a receiver 212. Furthermore, the second communication unit 220 may include a transmitter 221 and a receiver 222. Note that the communication apparatus 200 operates as, for example, a master device and a slave device.

Note that the first communication unit 210 and the first PTP controller 230 are functions when the communication apparatus 200 functions as a master device. In addition, the second communication unit 220 and the second PTP controller 240 are functions when the communication apparatus 200 functions as a slave device.

The transmitter 211 transmits, for example, the first signal to the slave device. Furthermore, the receiver 212 receives, for example, the second signal from the slave device.

For example, the transmitter 221 transmits the second signal to the master device. Further, the receiver 222 receives the first signal from the master device, for example.

The first PTP controller 230 performs control related to the PTP as a master device, which is performed in the communication apparatus 200. Note that the first PTP controller 230 includes a time-point information controller 231, a management controller 232, and a synchronization controller 233. Note that the time-point information controller 231 is similar to the time-point information controller 121 in FIG. 2, and thus the description thereof will be omitted. In addition, the management controller 232 is similar to the management controller 122 in FIG. 2, and thus the description thereof will be omitted.

The synchronization controller 233 controls the synchronization process by using, for example, information regarding a time point or information of a clock used when the communication apparatus 200 serves as a slave device and performs the synchronization process with another communication apparatus (for example, the communication apparatus 100). In short, the synchronization controller 233 can obtain high-precision time-point information and a synchronization clock, which are obtained by the GNSS communication unit 150, for example, when operating as a slave device.

The second PTP controller 240 performs control related to the PTP as a slave device, which is performed in the communication apparatus 200. Specifically, when transmitting a signal, the second PTP controller 240 can perform control such as obtaining of information regarding a time point (may be referred to as time-point information below) such as a time stamp. Furthermore, the second PTP controller 240 performs synchronization control with a master device based on, for example, time-point information included in a signal received by the receiver 222 and time-point information obtained when the transmitter 221 transmits the signal. Note that the second PTP controller 240 may be referred to as a controller.

Furthermore, details of the second PTP controller 240 will be described. The second PTP controller 240 includes a time-point information controller 241 and a management controller 242. The time-point information controller 241 performs control related to time-point information, for example. Specifically, for example, the time-point information controller 241 generates time-point information, determines whether time-point information is needed for a transmission signal, controls obtaining of time-point information corresponding to the transmission signal (for example, Delay_Req Message), and obtains time-point information (for example, a time stamp) corresponding to reception of a reception signal (for example, Sync Message). For example, the management controller 242 performs extraction of time-point information included in a received signal, extraction and analysis of other types of information included in a reception signal, and reading of time-point information (for example, a time stamp) obtained by the time-point information controller 241, and performs the synchronization process with a master device. Note that the storage unit 250 may retain time-point information.

The storage unit 250 can store, for example, information in a reception signal, time-point information, and the like.

The processor 260 performs an encryption process on a signal to be transmitted. Furthermore, the processor 260 performs a decryption process on a signal received by the receiver 212 or the receiver 222. Note that the processor 260 may be described separately as a first processor that performs an encryption process and a second processor that performs a decryption process. In addition, the processor 260 may be divided into one for a master device and one for a slave device.

Furthermore, details of the processor 260 will be described. The processor 260 includes a security function unit 261. The security function unit 261 includes an encryption/decryption processor 261-1, a buffer unit 261-2, and a timer unit 261-3. The encryption/decryption processor 261-1 performs an encryption process on a signal to be transmitted. Furthermore, the encryption/decryption processor 261-1 performs a decryption process on the signal received by the receiver 212 or the receiver 222. The buffer unit 261-2 can temporarily store the encrypted or decrypted signal. Furthermore, the timer unit 261-3 can measure a time by starting a timer. The timer unit 261-3 starts the timer, for example, at the time of starting the encryption process or the decryption process or at a timing before the start.

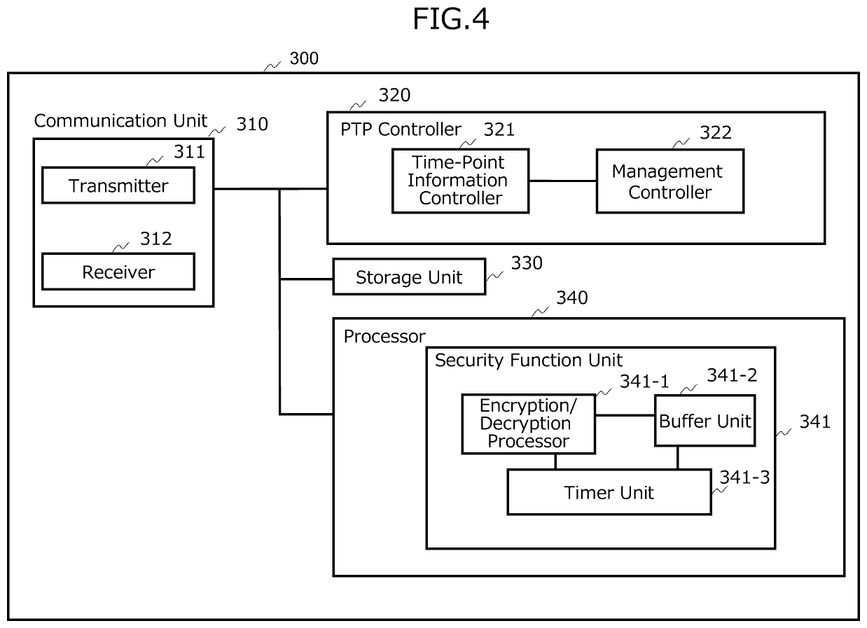

Next, the communication apparatus 300 will be described. FIG. 4 illustrates an example of a functional configuration diagram of the communication apparatus 300. The communication apparatus 300 includes a communication unit 310, a PTP controller 320, a storage unit 330, and a processor 340. Note that the communication unit 310 may include a transmitter 311 and a receiver 312.

The communication unit 310 communicates with the communication apparatus 200B via the communication network S12, for example. Note that the transmitter 311 performs, for example, a process related to transmission in the communication unit 310. Furthermore, the receiver 312 performs, for example, a process related to reception in the communication unit 310.

The communication unit 310 of the communication apparatus 300 can be configured to communicate with the communication apparatus 100 by being connected to the communication apparatus 100 via the communication network S12.

Note that the communication apparatus 300 operates as, for example, a slave device. For example, the transmitter 311 transmits the second signal to a master device. For example, the receiver 312 receives the first signal from a master device.

Note that a communication port for operating as a slave device is one port. Redundant ports may be configured.

The PTP controller 320 performs control related to the PTP performed in the communication apparatus 300. Note that specific contents of the PTP controller 320 are similar to those of the second PTP controller 240 described with reference to FIG. 3. Therefore, the time-point information controller 321 is similar to the time-point information controller 241 described with reference to FIG. 3. In addition, the management controller 322 is similar to the management controller 242 described with reference to FIG. 3. Therefore, the description thereof will be omitted. Note that the PTP controller 320 may be referred to as a controller.

The storage unit 330 can store, for example, information in a reception signal, time-point information, and the like.

The processor 340 performs an encryption process on a signal to be transmitted. Furthermore, the processor 340 performs a decryption process on the signal received by the receiver 312. Note that the processor 340 may be described separately as a first processor that performs an encryption process and a second processor that performs a decryption process.

Furthermore, details of the processor 340 will be described. The processor 340 includes a security function unit 341. The security function unit 341 includes an encryption/decryption processor 341-1, a buffer unit 342-2, and a timer unit 343-3. The encryption/decryption processor 341-1 performs an encryption process on a signal to be transmitted. Furthermore, the encryption/decryption processor 341-1 performs a decryption process on the signal received by the receiver 312. The buffer unit 341-2 can temporarily store the encrypted or decrypted signal. Furthermore, the timer unit 341-3 can measure a time by starting a timer. The timer unit 341-3 starts the timer, for example, at the time of starting the encryption process or the decryption process or at a timing before the start.

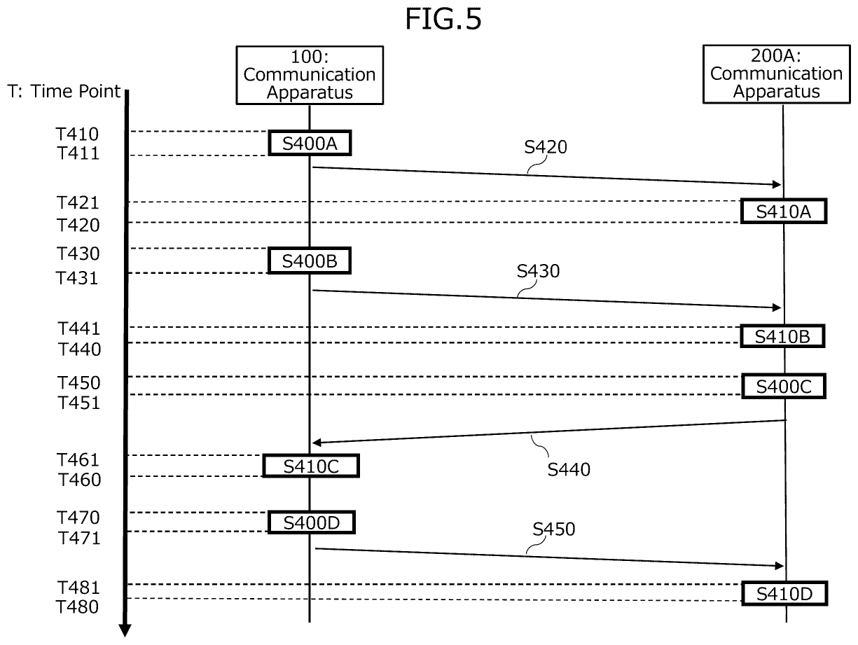

An operation of the communication system 1 in the first embodiment will be described with reference to FIGS. 5 to 7.

FIG. 5 is a diagram illustrating an example of a sequence of the communication system 1 in the first embodiment. Note that, in a case where Steps S400A, S400B, S400C, and S400D are not distinguished from each other, Steps S400A, S400B, S400C, and S400D may be referred to as Step S400. Similarly, in a case where Steps S410A, S410B, S410C, and S410D are not distinguished from each other, Steps S410A, S410B, S410C, and S410D may be referred to as Step S410. Note that, in the description of FIG. 5, processing of the communication apparatus 100 will be described as a master device, and processing of the communication apparatus 200A will be described as a slave device, but the present embodiment is not limited thereto.

The processor 140 of the communication apparatus 100 performs a process for transmitting a signal (for example, the first signal) (Step S400A). Note that the signal in Step S400A is, for example, an Announce Message that is an example of the first signal. Furthermore, the signal in Step S400A is an example of the first signal of the second type, for example.

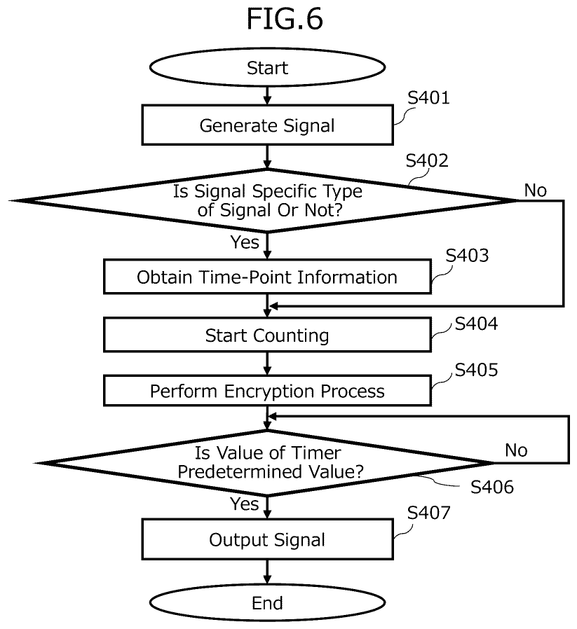

Here, the process for transmitting a signal will be described with reference to FIG. 6. FIG. 6 is a diagram illustrating an example of a flowchart of a process that includes a first process including the encryption process and is performed by the communication apparatus 100 and the communication apparatus 200 when a signal is transmitted. Note that, in the following description of FIG. 6, the process of the communication apparatus 100 will be described, but the similar process can also be performed in the communication apparatus 200.

When a signal to be transmitted is generated (Step S401), the PTP controller 120 determines whether or not the generated signal is, for example, a specific type of signal (Step S402). For example, the PTP controller 120 makes a determination according to the type of a signal to be transmitted. For example, in a case where the type of the signal to be transmitted is the second type, the PTP controller 120 determines that the signal is a signal for which time-point information is not obtained. Furthermore, in a case where the type of the signal to be transmitted is the first type, the PTP controller 120 determines that the signal is a signal for obtaining time-point information.

In a case where it is determined that the signal is the specific type of signal (Step S402: Yes), the PTP controller 120 obtains time-point information (Step S403). Note that the PTP controller 120 obtains, for example, first time-point information, and attaches the first time-point information to the first signal of the first type. Furthermore, the second PTP controller 240 obtains, for example, third time-point information. The obtained third time-point information is retained in the storage unit 250. Note that, for example, the time-point information controller 121 obtains the time-point information. Note that, regarding obtaining of the time-point information, it is possible to improve synchronization precision by embedding a time stamp in hardware. Note that the signal to which the time-point information is attached may be described as a signal in which the time-point information is embedded or a packet in which the time-point information is embedded. Note that the PTP controller 120 is an example of an operation in the master device, and the second PTP controller 240 is an example of the operation in the slave device.

In addition, in a case where it is determined that the signal is not the specific type of signal (Step S402: No), the PTP controller 120 of the communication apparatus 100 performs the process of Step S404 without obtaining the time-point information.

The processor 140 starts counting of the timer (Step S404). Note that the counting value when the timer is started is not 0 in some cases. Note that the timer only needs to be started before the encryption process performed in Step S405. For example, the timer may be started at the same time as the attachment of the time-point information, or may be started at a timing at which a signal to be subject to the encryption process is input after the time-point information is attached. In addition, the timer may be started at a starting timing of the encryption process performed in Step S405. Furthermore, the start of the timer of the communication apparatus 100 is controlled by the timer unit 141-3, for example. Note that the timer used by the master device (for example, the communication apparatus 100) in the first process including encryption is an example of a first timer. In addition, the timer used by the slave device (for example, the communication apparatus 200) in the first process including encryption is an example of a third timer. Note that the first timer is a timer that measures a first time. In addition, the third timer is a timer that measures a third time.

The processor 140 performs the encryption process on a signal to be transmitted (Step S405). Note that the encryption process of the communication apparatus 100 is performed by, for example, the encryption/decryption processor 141-1.

The processor 140 determines whether or not the value of the timer reaches a predetermined value (Step S406). Note that the value of the timer when the timer is started is not 0 in some cases. Furthermore, the predetermined value is, for example, a value corresponding to a time longer than the maximum time of a time taken for the encryption process of a signal and the decryption process of a signal in the communication apparatus 100. Note that the encrypted signal is retained in the buffer unit 141-2, for example, until the value of the timer reaches the predetermined value. Note that the value of the timer may be counted by a subtraction process or may be counted by an addition process. For example, in a case where counting is performed in the subtraction process, the value at the start of the timer corresponds to a first processing time, and the predetermined value is 0. Furthermore, for example, in a case where counting is performed in the addition process, for example, a value obtained by subtracting the value at the start of the timer from the predetermined value corresponds to the first processing time.

In a case where the value of the timer is the predetermined value (Step S406: Yes), the processor 140 outputs the encrypted signal (Step S407). For example, the encrypted signal is output from the buffer unit 141-2. Note that the fact that the value of the timer is the predetermined value may be described as that the timer has expired or that the measurement of the timer has expired.

In addition, in a case where the value of the timer is not the predetermined value (Step S406: No), the process returns to Step S406.

Note that the first process including the encryption process of a signal corresponds to, for example, Steps S404 to S406 in FIG. 6. In short, a period from the start of counting by the timer until the value of the timer reaches the predetermined value is the first process. Therefore, the time taken for the first process is, for example, from the start of counting by the timer until the value of the timer reaches the predetermined value.

The description returns to FIG. 5. The transmitter 111 of the communication apparatus 100 transmits the encrypted signal to the communication apparatus 200A (Step S420). Furthermore, the receiver 222 of the communication apparatus 200A receives the encrypted signal (Step S420). Note that the signal transmitted in Step S420 is, for example, the first signal of the second type, and thus time-point information is not attached thereto.

The processor 260 of the communication apparatus 200A performs a process for receiving the encrypted signal (Step S410A).

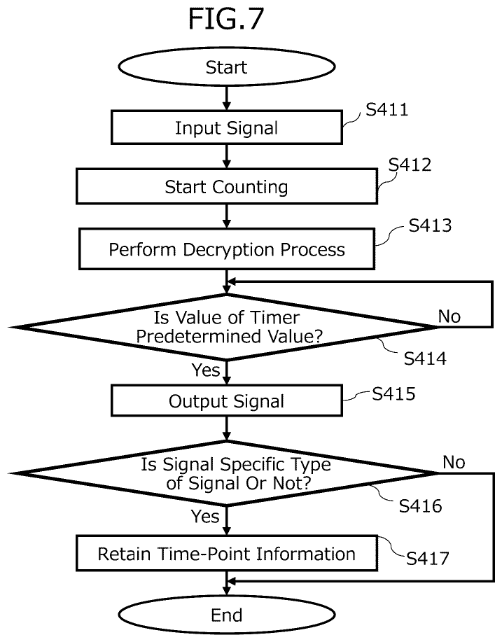

Here, the process for receiving a signal will be described with reference to FIG. 7. FIG. 7 is a diagram illustrating an example of a flowchart of a process that includes a second process including the decryption process and is performed by the communication apparatus 100 and the communication apparatus 200 when a signal is received. Note that, in the following description of FIG. 7, the process of the communication apparatus 200 will be described, but the similar process can also be performed in the communication apparatus 100. In that case, for example, the communication unit 110 performs the process of the second communication unit 220, the PTP controller 120 performs the process of the second PTP controller 240, and the processor 140 performs the process of the processor 260.

The signal received by the receiver 222 is input to the processor 260 (Step S411).

The processor 260 receives the input of the signal and starts counting of the timer (Step S412). Note that the value of the timer when the timer is started is not 0 in some cases. In addition, the timer may be started at a timing before the decryption process in Step S413 or a timing at which the decryption process is started. In addition, the start of the timer is controlled by the timer unit 261-3. Note that the value of the timer may be counted by a subtraction process or may be counted by an addition process. For example, in a case where the timer is counted in the subtraction process, the value at the start of the timer corresponds to a second processing time, and the predetermined value is 0. Furthermore, for example, in a case where the timer is counted in the addition process, for example, a value obtained by subtracting the value at the start of the timer from the predetermined value corresponds to the second processing time. Note that the timer used by the slave device (for example, the communication apparatus 200) in the second process including decryption is an example of a second timer. In addition, the timer used by the master device (for example, the communication apparatus 100) in the second process including decryption is an example of a fourth timer. Note that the second timer is a timer that measures a second time. In addition, the fourth timer is a timer that measures a fourth time.

The processor 260 performs the decryption process on the input signal (Step S413). Note that the decryption process is performed by, for example, the encryption/decryption processor 261-1.

The processor 260 determines whether or not the value of the timer reaches a predetermined value (Step S414). Note that the predetermined value is, for example, a value that is a time longer than the maximum time of a time taken for the encryption and decryption processes of a signal in the communication apparatus 200. Note that the decrypted signal is retained in the buffer unit 261-2, for example, until the value of the timer reaches the predetermined value.

In a case where the timer has the predetermined value (Step S414: Yes), the processor 260 outputs the signal (Step S415). For example, the decrypted signal is output from the buffer unit 261-2. Note that the fact that the value of the timer is the predetermined value may be described as that the timer has expired or that the measurement of the timer has expired.

In addition, in a case where the timer does not have the predetermined value (Step S414: No), the process returns to Step S414.

The second PTP controller 240 determines whether or not the signal output from the buffer unit 261-2 is a specific type of signal (Step S416). For example, in a case where the type of the received signal is the second type, the second PTP controller 240 determines that the signal is a signal for which time-point information is not obtained. Furthermore, in a case where the type of the received signal is the first type, the second PTP controller 240 determines that the signal is a signal for obtaining time-point information. Note that the obtained time-point information is stored, for example, in the second PTP controller 240, the storage unit 250, or the like. Note that the obtained time-point information is, for example, a reception time stamp.

In a case where it is determined that the signal is the specific type of signal (first type) (Step S416: Yes), the second PTP controller 240 obtains time-point information at that time and retains the obtained time-point information (Step S417). For example, in the case of Step S410B of FIG. 5, second time-point information (T440) corresponding to the received signal is retained in the storage unit 250.

In addition, in a case where it is determined that the signal is not the specific type of signal (second type) (Step S416: No), information in the received signal is retained in, for example, the storage unit 250. Note that the information in the received signal is, for example, needed for the synchronization process. The information in the received signal is, for example, information transmitted in an Announce Message (precision information of a clock or the like) or information transmitted in a Delay_Resp Message (for example, time-point information of T440 or the like).

Note that the second process including the decryption process of a signal is performed in Steps S412 to S414 in FIG. 7, for example. In short, a period from the start of counting by the timer until the value of the timer reaches the predetermined value is the second process. Therefore, the time taken for the second process is, for example, from the start of counting by the timer until the value of the timer reaches the predetermined value.

The description returns to FIG. 5. The communication apparatus 100 performs a process for transmitting a signal (Step S400B). Note that, in Step S400B, a process for transmitting the first signal of the first type is performed. Therefore, the PTP controller 120 of the communication apparatus 100 performs a process of obtaining the first time-point information (T430) (Step S403 in FIG. 6). Note that the obtained first time-point information is attached to a signal to be transmitted. The processor 140 of the communication apparatus 100 performs the first process including the encryption process of a signal to which the first time-point information is attached (Steps S404 to S406 in FIG. 6). Note that the signal processed in Step S400B is, for example, a Sync Message. Note that details of the process in Step S400B are the same as the contents described in FIG. 6, and thus description thereof will be omitted.

The transmitter 111 of the communication apparatus 100 transmits a signal encrypted by the process included in Step S400B to the communication apparatus 200A (Step S430). Furthermore, the receiver 222 of the communication apparatus 200A receives the encrypted signal (Step S430).

The communication apparatus 200A performs a process for receiving the encrypted signal (Step S410B). Specifically, the processor 260 of the communication apparatus 200A performs the second process including the decryption process of the received signal (Steps S412 to S414 in FIG. 7). Since the received signal is the first signal of the first type, the second PTP controller 240 of the communication apparatus 200A obtains the second time-point information (T440) corresponding to the received signal and retains the second time-point information (Step S417 in FIG. 7). Note that details of the process in Step S410B are the same as the contents described in FIG. 7, and thus description thereof will be omitted.

Then, the communication apparatus 200A performs a process for transmitting a signal (Step S400C). Note that the signal transmitted in Step S400C is, for example, the second signal of the first type. Note that the second signal is a signal intended to obtain third time-point information and fourth time-point information. Specifically, the second PTP controller 240 of the communication apparatus 200A performs a process of obtaining the third time-point information (T450) (Step S403 in FIG. 6). The processor 260 of the communication apparatus 200A performs the first process including the encryption process of the second signal (Steps S404 to S406 in FIG. 6). Note that the signal encrypted by the process included in Step S400C is, for example, a Delay_Req Message. Note that details of the process in Step S400C are the same as the contents described in FIG. 6, and thus description thereof will be omitted.

The transmitter 221 of the communication apparatus 200A transmits the signal encrypted by the process included in Step S400C to the communication apparatus 100 (Step S440). Furthermore, the receiver 112 of the communication apparatus 100 receives the encrypted signal (Step S440).

The communication apparatus 100 performs a process for receiving the encrypted signal (Step S410C). Specifically, the processor 140 of the communication apparatus 100 performs the second process including the decryption process of the second signal (Steps S412 to S414 in FIG. 7). The PTP controller 120 of the communication apparatus 100 obtains the fourth time-point information (T460) corresponding to the third signal, and retains the fourth time-point information (Step S417 in FIG. 7). Note that details of the process in Step S410C are the same as the contents described in FIG. 7, and thus description thereof will be omitted.

Thereafter, the communication apparatus 100 performs a process for transmitting a signal (Step S400D). Specifically, the processor 140 of the communication apparatus 100 performs the first process including the encryption process of a signal (Steps S404 to S406 in FIG. 6). Note that the signal processed in Step S400D is, for example, the first signal of the second type. Furthermore, the signal processed in Step S400D may be referred to as, for example, a Delay_Resp Message. Note that the signal processed in Step S400D includes, for example, the fourth time-point information obtained in Step S410C. Note that details of the process in Step S400D are the same as the contents described in FIG. 6, and thus description thereof will be omitted. Note that the signal processed in Step S400D is an example of the first signal of the second type.

The transmitter 111 of the communication apparatus 100 transmits the encrypted signal to the communication apparatus 200A (Step S450). Furthermore, the receiver 222 of the communication apparatus 200A receives the encrypted signal (Step S450).

The communication apparatus 200A performs a process for receiving the encrypted signal (Step S410D). Specifically, the processor 260 of the communication apparatus 200A performs the second process including the decryption process of the encrypted first signal (Steps S412 to S414 in FIG. 7). Note that details of the process in Step S410D are the same as the contents described in FIG. 7, and thus description thereof will be omitted. Note that, in a case where the received signal includes the fourth time-point information, the second PTP controller 240 of the communication apparatus 200A obtains the fourth time-point information (T460) and retains the fourth time-point information.

Next, details of a method of performing the synchronization process with the communication apparatus 100 by using the first time-point information to the fourth time-point information in the communication apparatus 200A will be described.

The second PTP controller 240 of the communication apparatus 200A determines a time T1 (=T440−T430) that is a difference between time points, for example, by using the first time-point information (T430) and the second time-point information (T440). In addition, a time T2 (=T460−T450) that is a difference between time points is determined by using the third time-point information (T450) and the fourth time-point information (T460). Note that the fourth time-point information is transmitted by using, for example, a signal transmitted from the communication apparatus 100 to the communication apparatus 200A. As described in Expression 1 as follows, a time T3 obtained by subtracting the time T2 from the time T1 is determined.

$$T 3 = ( T 440 - T 430 ) - ( T 460 - T 450 ) \qquad ( Expression 1 )$$

The second PTP controller 240 determines a time T4 (=(T3)/2) that is half of the time T3. Note that this determination method is an example. For example, when the second PTP controller 240 of the communication apparatus 200A determines the time T3, the time T2 may be determined first, and the time T1 and the time T2 may be determined simultaneously. In addition, without obtaining the time T1 and the time T2, the four terms of Expression 1 may be appropriately interchanged in a range that does not affect the calculation result. In short, the second PTP controller 240 determines the time T3 by using the first time-point information to the fourth time-point information.

The time T4 is a difference (deviation) of the time point of the communication apparatus 200A with respect to the communication apparatus 100. Thus, by correcting the time point of the communication apparatus 200A by using the time T4, the synchronization process between the communication apparatus 100 and the communication apparatus 200A is performed. Note that this difference may also be referred to as Offset of slave.

Note that, in Step S400 that is the first process and Step S410 that is the second process, the defined predetermined values are set to the same value for each of the communication apparatus 100 and the communication apparatus 200. Furthermore, in the communication apparatus 100 and the communication apparatus 200, a common predetermined value may be used or may be different for each device.

Thus, a time (for example, T431-T430) taken for the encryption and decryption processes of the corresponding signal in the first process and the second process can be determined to be a predetermined time for each of the communication apparatus 100 and the communication apparatus 200. Therefore, the time T1 and the time T2 can be set to a coinciding predetermined time.

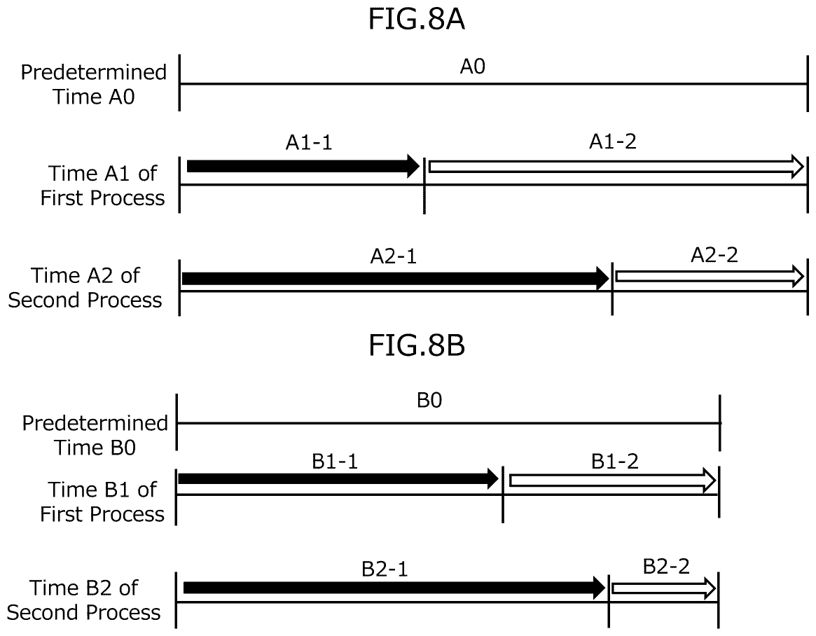

Next, processing times in the first process and the second process will be described. FIGS. 8A and 8B are diagrams illustrating an example of a relationship among the defined predetermined time, a time taken for the first process, and a time taken for the second process.

FIG. 8A is a diagram illustrating a first example of a relationship among the defined predetermined time A0, a time A1 taken for the first process, and a time A2 taken for the second process. Note that FIG. 8A is applied to, for example, the communication apparatus 100.

The predetermined time A0 is, for example, a time corresponding to a predetermined value defined in FIGS. 6 and 7. The time A1 of the first process includes a time A1-1 and a time A1-2. The time A1-1 corresponds to a time taken to encrypt the signal. In addition, the time A1-2 corresponds to a difference between the time A0 and the time A1-1, and corresponds to, for example, a time at which a signal is stored in the buffer unit 141-2. Note that the time A1 of the first process corresponds to a first time counted by the first timer.

In addition, the time A2 of the second process includes a time A2-1 and a time A2-2. The time A2-1 corresponds to a time taken to decrypt the signal. In addition, the time A2-2 corresponds to a difference between the time A0 and the time A2-1, and corresponds to, for example, a time at which a signal is stored in the buffer unit 141-2. Note that the time A2 of the second process corresponds to a fourth time counted by the fourth timer. Thus, in a case where the first process and the second process are not simultaneously performed, the processor 140 may retain the first timer and the fourth timer as one timer.

Note that the time for encrypting and decrypting the signal may vary for each signal depending on, for example, the property of the signal. Therefore, by determining the predetermined time A0 corresponding to a predetermined value longer than the maximum time of the times taken to encrypt and decrypt the signal, it is possible to set a fixed processing time regardless of the times for encrypting and decrypting the signal in the communication apparatus 100.

Specifically, the time A1-2 that is the standby time is provided after the time A1-1 such that the time A1 becomes the time A0. Similarly, the time A2-2 that is the standby time is provided after the time A2-1 such that the time A2 becomes the time A0. In this manner, the time A1 and the time A2 are unified to the time A0. In short, the time A1 and the time A2 are the same time.

FIG. 8B is a second example for describing a relationship among a defined predetermined time B0, a time B1 taken for the first process, and a time B2 taken for the second process. Note that FIG. 8B is applied to, for example, the communication apparatus 200A.

The predetermined time B0 is, for example, a time corresponding to a predetermined value defined in FIGS. 6 and 7. The time B1 of the first process includes a time B1-1 and a time B1-2. The time B1-1 corresponds to a time taken to encrypt the signal. In addition, the time B1-2 corresponds to a difference between the time B0 and the time B1-1, and corresponds to, for example, a time at which the signal is stored in the buffer unit 261-2. Note that the time B1 of the first process corresponds to a time counted by the third timer.

In addition, the time B2 of the second process includes a time B2-1 and a time B2-2. The time B2-1 corresponds to a time taken to decrypt the signal. In addition, the time B2-2 corresponds to a difference between the time B0 and the time B2-1, and corresponds to, for example, a time at which the signal is stored in the buffer unit 261-2. Note that the time B2 of the second process corresponds to a second time counted by the second timer. Therefore, in the first embodiment, the second timer and the third timer count the same value. Thus, in a case where the first process and the second process are not simultaneously performed, the processor 260 may retain the second timer and the third timer as one timer.

The time for encrypting and decrypting the signal may vary for each signal depending on, for example, the property of the signal. Therefore, by determining the predetermined time B0 corresponding to a predetermined value longer than the maximum time of the times taken to encrypt and decrypt the signal, it is possible to set a fixed processing time regardless of the times for encrypting and decrypting the signal in the communication apparatus 200A.

Specifically, the time B1-2 that is the standby time is provided after the time B1-1 such that the time B1 becomes the time B0. Similarly, the time B2-2 which is the standby time is provided after the time B2-1 such that the time B2 becomes the time B0. In this manner, the time B1 and the time B2 are unified to the time B0. In short, the time B1 and the time B2 are the same time.

As a result, in the communication apparatus 100 and the communication apparatus 200, the time taken for the first process and the time taken for the second process can be unified to a predetermined time for each of the communication apparatus 100 and the communication apparatus 200.

Note that, even in a case where the synchronization process is repeatedly performed, since the time taken for the first process and the time taken for the second process are unified for each of the communication apparatus 100 and the communication apparatus 200, the time T1 and the time T2 are unified to a predetermined time.

Therefore, the time T3 and the time T4 can also be determined to be fixed times as long as the time T3 and the time T4 are in a synchronous state.

Thus, a difference (deviation) of the time point of the communication apparatus 200A with respect to the communication apparatus 100 can be set to a time corresponding to a predetermined value. Therefore, for example, the time T4 can be made fixed. As a result, since the influence of the difference in processing time due to the encryption and decryption processes can be reduced, the fluctuation for each synchronization process is reduced, so that it is possible to secure the synchronization precision.

Note that the predetermined times A0 and B0 may be the same time. Furthermore, for example, the predetermined time A0 may be set by using the time A1-1 and the time A2-1. Furthermore, the predetermined time A0 may be set, for example, according to a cycle of the first signal.

As described above, in the first embodiment, in the communication apparatus 100 and the communication apparatus 200, the times taken for the first process and the second process can be made fixed for each of the communication apparatus 100 and the communication apparatus 200. Therefore, since the influence of the difference in processing time due to the encryption and decryption processes can be reduced, it is possible to secure the synchronization precision. For example, since the times taken for the first process and the second process are the same, it is possible to prevent deterioration in synchronization precision due to encryption and decryption processes for a packet. Therefore, it is possible to maintain synchronization precision.

Note that the communication apparatus 100 and the communication apparatus 200 identify a first packet that is a PTP packet and a second packet that is a packet other than the PTP packet. In addition, as a method of identification, for example, a MAC address is used for allocation. In the case of the first packet, the communication apparatus 100 and the communication apparatus 200 may perform a process having the contents described in the first embodiment. Furthermore, in the case of the second packet, the communication apparatus 100 and the communication apparatus 200 may perform control so as not to perform time adjustment. In this manner, since a time matching process can be omitted for the second packet, it is possible to accelerate a process for the second packet.

Note that, at the time of transmission, a transmission timing of the first packet needs to be strictly observed. This is to prevent an occurrence of a situation in which the second packet is transmitted at the transmission timing of the first packet because the transmission timing of the first packet is known in advance. In short, when the transmission timing of the first packet is approached, control may be performed such that only a packet that does not overlap the transmission timing of the first packet passes in accordance with the packet length of the second packet. Note that, when the transmission timing of the first packet arrives, the first packet is transmitted, and then the second packet is caused to pass through until the transmission timing of the next first packet comes close.

### Second Embodiment

In the first embodiment, an example in which the times taken for the first process and the second process can be made fixed for each of the communication apparatus 100 and the communication apparatus 200 when the time-point information corresponding to the signal is controlled in the synchronization process has been described. In a second embodiment, an example in which, when time-point information corresponding to a signal is controlled for each of a communication apparatus 100 and a communication apparatus 200, the time taken for the first process and the time taken for the second process are fixed times will be described. Note that a communication system 1 in the second embodiment is similar to that in the first embodiment, and therefore the description thereof will be omitted.

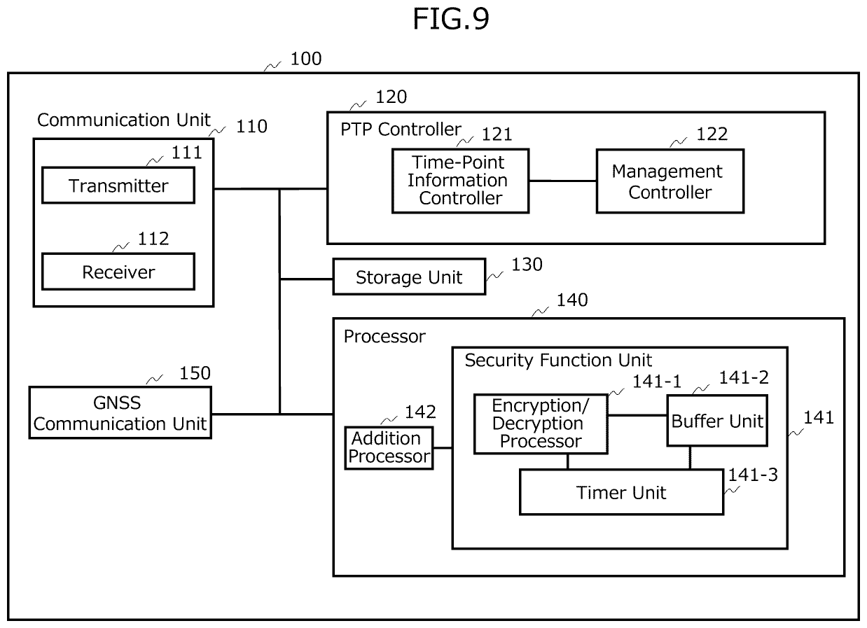

The communication apparatus 100 in the second embodiment will be described. FIG. 9 is a diagram illustrating an example of a functional configuration diagram of the communication apparatus 100. Note that the same components as those in FIG. 2 are denoted by the same reference signs, and the description thereof will be omitted.

A processor 140 of the communication apparatus 100 further includes an addition processor 142 in addition to the configuration illustrated in FIG. 2. The addition processor 142 can perform an addition process on a numerical value or the like in a signal.

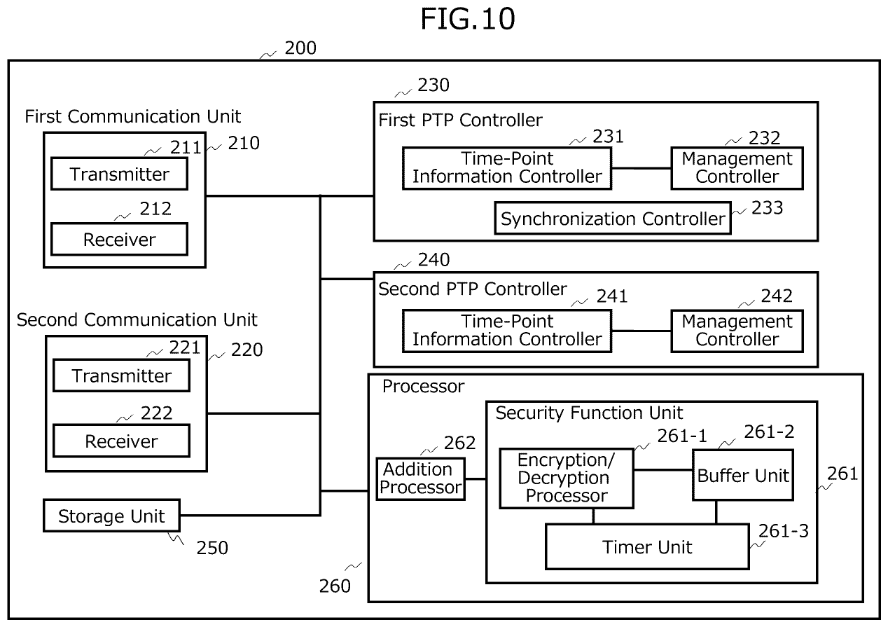

Next, a communication apparatus 200 in the second embodiment will be described. FIG. 10 is a diagram illustrating an example of a functional configuration diagram of the communication apparatus 200. Note that the same components as those in FIG. 3 are denoted by the same reference signs, and the description thereof will be omitted.

A processor 260 of the communication apparatus 200 further includes an addition processor 262 in addition to the configuration illustrated in FIG. 3. The addition processor 262 can perform an addition process on a numerical value or the like in a signal.

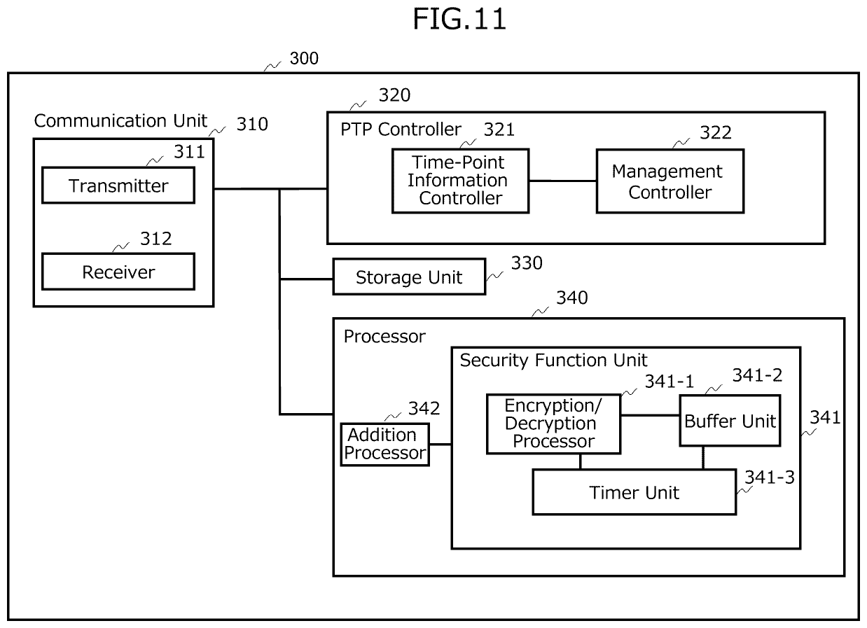

Next, a communication apparatus 300 in the second embodiment will be described. FIG. 11 is a diagram illustrating an example of a functional configuration diagram of the communication apparatus 300. Note that the same components as those in FIG. 4 are denoted by the same reference signs, and the description thereof will be omitted.

A processor 340 of the communication apparatus 300 further includes an addition processor 342 in addition to the configuration illustrated in FIG. 4. The addition processor 342 can perform an addition process on a numerical value or the like in a signal.

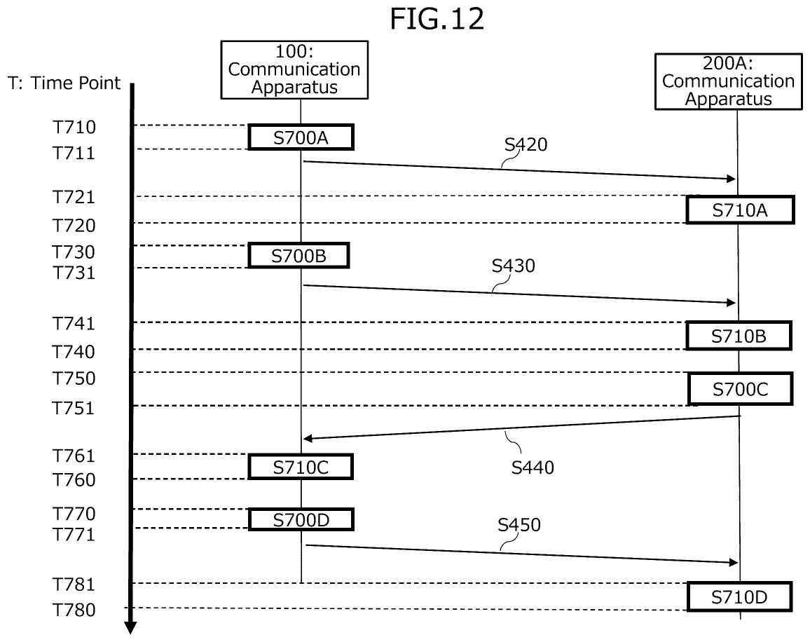

An operation of the communication system 1 in the second embodiment will be described with reference to FIGS. 12 to 14.

First, information included in a signal to be transmitted in the second embodiment will be described. The signal to be transmitted in the second embodiment may include, for example, time-point information such as a time stamp, as in the first embodiment. Further, information regarding a time, which is called a correction field (referred to as a CF below) may be included. The CF includes, for example, information of a delay that occurs in the communication apparatus via communication and a time taken for encryption, decryption, and the like. These times are added to values in the CF and accumulated. The communication apparatus that has received a signal can determine a time taken for transmission on a communication path and a difference in time between the communication apparatuses performing synchronization, by subtracting the value of the CF from a difference in time-point information between the communication apparatuses. Note that an initial value of the value of the CF is 0. In addition, the CF is not limited to this name as long as the CF has an equivalent function, and other names may be used.

FIG. 12 is a diagram illustrating an example of a sequence of the communication system 1 in the second embodiment. Note that, in a case where Steps S700A, S700B, 5700C, and S700D are not distinguished from each other, Steps S700A, S700B, S700C, and S700D may be referred to as Step S700. Similarly, in a case where Steps S710A, S710B, S710C, and S710D are not distinguished from each other, Steps S710A, S710B, S710C, and S710D may be referred to as Step S710. Note that, in FIG. 10, the same step numbers are assigned to the same processes as those in FIG. 5, and the description thereof will be omitted.

The communication apparatus 100 performs a process for transmitting a signal (Step S700A). Note that the signal processed in Step S700A is, for example, the first signal of the second type. Furthermore, the signal processed in Step S700A may be referred to as, for example, an Announce Message.

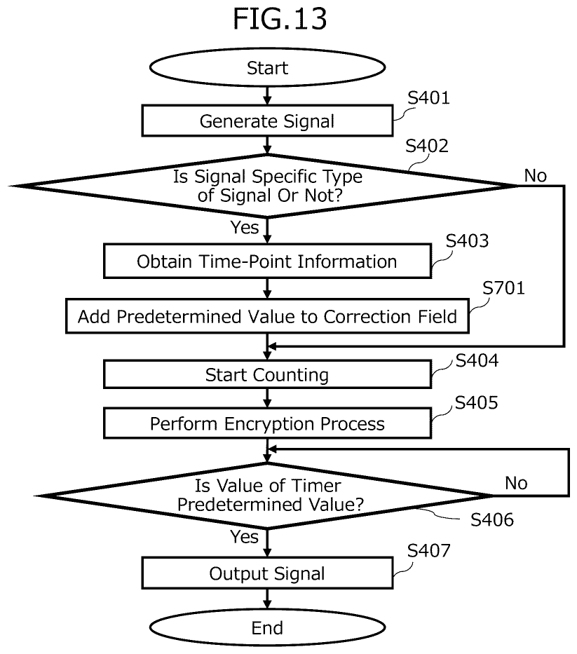

Here, processing at the time of transmitting a signal, which includes a first process including an encryption process of a signal performed in Step S700 will be described with reference to FIG. 13. FIG. 13 is a diagram illustrating an example of a flowchart of a process that includes a first process including the encryption process and is performed by the communication apparatus 100 and the communication apparatus 200 when a signal is transmitted. Note that the first process including the encryption process of a signal is performed, for example, in Step S700. Note that, in FIG. 13, the same step numbers are assigned to the same processes as those in FIG. 6, and the description thereof will be omitted. In addition, in the following description of FIG. 13, the process of the communication apparatus 100 will be described, but the similar process can also be performed in the communication apparatus 200.

The PTP controller 120 determines whether or not the signal is, for example, a specific type of signal (Step S402). For example, in a case where the type of the signal to be transmitted is the second type, the PTP controller 120 determines that the signal is a signal for which time-point information is not obtained. Furthermore, in a case where the type of the signal to be transmitted is the first type, the PTP controller 120 determines that the signal is a signal for obtaining time-point information.

In a case where it is determined that the signal is the specific type of signal (Step S402: Yes), the PTP controller 120 obtains time-point information (for example, a time stamp) (Step S403). Note that the PTP controller 120 may attach the obtained time-point information to the signal. In addition, the processor 140 adds a predetermined value to a value of CF1 that is the CF of the signal (Step S701). Note that the predetermined value is, for example, a value corresponding to a first time corresponding to a time of the first process in a Sync Message that is an example of a first signal, or corresponding to a ½ ((the first time−a fourth time)+2) of a difference between the first time corresponding to the time of the first process and the fourth time corresponding to the time of the second process, in the communication apparatus 100. Note that a process of adding a predetermined value to the value of CF1 is performed by, for example, the addition processor 142.

Note that, in the case of the communication apparatus 200A that performs the synchronization process as a slave device, for example, the processor 260 adds, to CF2 that is a CF of a second signal, as a predetermined value, a value corresponding to a third time corresponding to the time of the first process or corresponding to a value (−{(second time−third time)−2}) obtained by adding a negative sign to ½ of a difference between the second time corresponding to the time of the second process and the third time corresponding to the time of the first process.

In addition, in a case where it is determined that the signal is not a signal to which the time-point information is attached (Step S402: No), the PTP controller 120 of the communication apparatus 100 performs the process of Step S404 without attaching the time-point information to the signal.

The processor 140 starts counting of the timer (Step S404). Note that the counting value when the timer is started is not 0 in some cases. In addition, the start of the timer is controlled by the timer unit 141-3. The processor 140 determines whether or not the value of the timer is a predetermined value (Step S406). Note that the predetermined value is, for example, a value that is a time longer than the maximum time of a time taken for the encryption process of a signal in the communication apparatus 100.

Note that the first process including the encryption process of a signal corresponds to, for example, Steps S404 to S406 in FIG. 13.

The description returns to FIG. 12. The transmitter 111 of the communication apparatus 100 transmits a signal encrypted by the process of Step S700A to the communication apparatus 200A (Step S420). Furthermore, the receiver 222 of the communication apparatus 200A receives the encrypted signal (Step S420).

The processor 260 of the communication apparatus 200A performs a process at the time of receiving a signal, which includes the second process including the decryption process of the encrypted signal (Step S710A).

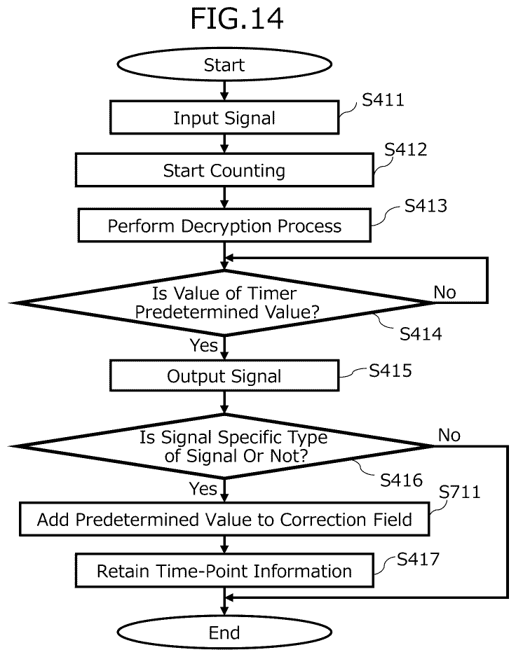

Here, the process at the time of receiving a signal, which includes the second process including the decryption process of a signal will be described with reference to FIG. 14. FIG. 14 is a diagram illustrating an example of a flowchart of a process that includes a second process including the decryption process and is performed by the communication apparatus 100 and the communication apparatus 200 when a signal is received. Note that the second process including the decryption process of a signal is performed, for example, in Step S710. Note that, in FIG. 14, the same step numbers are assigned to the same processes as those in FIG. 7, and the description thereof will be omitted. Note that, in the following description of FIG. 14, the process of the communication apparatus 200 will be described, but the similar process can also be performed in the communication apparatus 100.

The processor 260 determines whether or not the timer has a predetermined value (Step S414). Note that, in a case where the value at the start of the timer is not 0, it is determined whether counting of a predetermined value has progressed. Note that the predetermined value is, for example, a value that is a time longer than the maximum time of a time taken for the decryption process of a signal in the communication apparatus 200. Note that the decrypted signal is retained in the buffer unit 261-2, for example, until the value of the timer reaches the predetermined value.

In a case where the timer has the predetermined value (Step S414: Yes), the security function unit 261 outputs a signal stored in the buffer unit 261-2 (Step S415).

In addition, in a case where the value of the timer is not the predetermined value (Step S414: No), the process returns to Step S414.

The second PTP controller 240 determines whether or not the signal is the specific type of signal (Step S416). For example, the second PTP controller 240 makes a determination according to the type of the received signal. For example, in a case where the type of the received signal is the first type, the second PTP controller 240 determines that the signal is a signal for which the corresponding time-point information is obtained. Furthermore, in a case where the type of the received signal is the second type, the second PTP controller 240 determines that the signal is a signal for which the time-point information is not obtained.

In a case where it is determined that the signal is the specific type of signal (Step S416: Yes), the addition processor 262 adds a predetermined value to the value of CF1 that is the CF of the first signal (Step S711). The second PTP controller 240 obtains and retains the time-point information corresponding to the signal (Step S417). For example, in the case of Step S710A in FIG. 12, the second time-point information is obtained and retained. Note that the predetermined value is, for example, a value corresponding to the second time corresponding to the time of the second process in CF1 after decryption of a Sync Message that is an example of the first signal, or corresponding to a value ((the second time−the third time)−2) of a difference between the second time corresponding to the time of the second process and the third time corresponding to the time of the first process, in the communication apparatus 200. Note that a process of adding a predetermined value to the value of CF1 is performed by, for example, the addition processor 262.

Note that, in the case of the communication apparatus 100 that performs the synchronization process as the master device, for example, the processor 140 adds, to CF2 that is the CF of the second signal, as a predetermined value, a value corresponding to the fourth time corresponding to the time of the second process or a value corresponding to a value (−{(the first time−the fourth time)+2}obtained by adding a negative sign to ½ of a difference between the fourth time corresponding to the time of the second process and the first time corresponding to the time of the first process.

Note that, for example, in the communication apparatus 100, in a case where the first time is added to the CF of the first signal, the fourth time is added to the CF of the second signal. In addition, in a case where the value corresponding to ((the first time−the fourth time)+2) is added to the CF of the first signal, the value corresponding to (−{(the first time−the fourth time)+2}) is added to the CF of the second signal. Note that the same applies to the communication apparatus 200.

In addition, in a case where it is determined that the signal is not the specific type of signal (Step S416: No), the process ends.

Note that the second process including the decryption process of a signal is performed in Steps S412 to S414 in FIG. 14, for example. In short, a period from the start of counting by the timer until the value of the timer reaches the predetermined value is the second process. Therefore, the time taken for the second process is, for example, from the start of counting by the timer until the value of the timer reaches the predetermined value.

The description returns to FIG. 12. The communication apparatus 100 performs a process for transmitting a signal (Step S700B). Note that the signal processed in Step S700B is, for example, the first signal of the first type. Specifically, the PTP controller 120 of the communication apparatus 100 performs a process of attaching first time-point information (T730) to the signal (Step S403 in FIG. 13), and then, the processor 140 of the communication apparatus 100 performs the first process including the encryption process on the signal (Steps S404 to S406 in FIG. 13). Note that details of the process in Step S700B are the same as the contents described in FIG. 13, and thus description thereof will be omitted.

The transmitter 111 of the communication apparatus 100 transmits the signal encrypted in Step S700B to the communication apparatus 200A (Step S430). Furthermore, the receiver 222 of the communication apparatus 200A receives the encrypted signal (Step S430).

The communication apparatus 200A performs a process for receiving the encrypted signal (Step S710B). Specifically, the processor 260 of the communication apparatus 200A performs the second process including the decryption process of the second signal (Steps S412 to S414 in FIG. 14). The second PTP controller 240 of the communication apparatus 200A obtains second time-point information (T740) corresponding to the second signal, and retains the second time-point information (Step S417 in FIG. 14). Note that details of the process in Step S710B are the same as the contents described in FIG. 14, and thus description thereof will be omitted.

Then, the communication apparatus 200 performs a process for transmitting a signal (Step S700C). Specifically, the second PTP controller 240 of the communication apparatus 200A performs a process of obtaining third time-point information (T750) (Step S403 in FIG. 13). The processor 260 of the communication apparatus 200A performs the first process including the encryption process of the signal (Steps S404 to S406 in FIG. 13). Note that the signal processed in Step S700C is, for example, the second signal of the first type. Furthermore, the signal processed in Step S700C may be referred to as, for example, a Delay_Req Message. Note that details of the process in Step S700C are the same as the contents described in FIG. 13, and thus description thereof will be omitted. Note that a CF included in a third signal is, for example, CF2.

The transmitter 221 of the communication apparatus 200A transmits the signal encrypted in Step S700C to the communication apparatus 100 (Step S440). Furthermore, the receiver 112 of the communication apparatus 100 receives the encrypted signal (Step S440).

The communication apparatus 100 performs a process for receiving the encrypted signal (Step S710C). Specifically, the processor 140 of the communication apparatus 100 performs the second process including the decryption process of the encrypted signal (Steps S412 to S414 in FIG. 14). The PTP controller 120 of the communication apparatus 100 obtains and retains fourth time-point information (T760) corresponding to the signal (Step S417 in FIG. 14). Note that details of the process in Step S710C are the same as the contents described in FIG. 14, and thus description thereof will be omitted.

Thereafter, the communication apparatus 100 performs a process for transmitting a signal (Step S700D). Specifically, the processor 140 of the communication apparatus 100 performs the first process including the encryption process of a signal (Steps S404 to S406 in FIG. 13). Note that the signal transmitted in Step S700D is, for example, the first signal of the second type. Furthermore, the signal transmitted in Step S700D may be referred to as, for example, a Delay_Resp Message. Note that the signal processed in Step S700D includes, for example, the fourth time-point information obtained in Step S710C. Note that details of the process in Step S700D are the same as the contents described in FIG. 13, and thus description thereof will be omitted.

The transmitter 111 of the communication apparatus 100 transmits the encrypted signal to the communication apparatus 200A (Step S450). Furthermore, the receiver 222 of the communication apparatus 200A receives the encrypted signal (Step S450).

The communication apparatus 200A performs a process for receiving the encrypted signal (Step S710D). Specifically, the processor 260 of the communication apparatus 200A performs the second process including the decryption process of the signal (Steps S412 to S414 in FIG. 14). Note that details of the process in Step S710D are the same as the contents described in FIG. 14, and thus description thereof will be omitted.

In the following description, details of a method of performing the synchronization process by using the first time-point information to the fourth time-point information in the communication apparatus 200A will be described.

For example, the second PTP controller 240 of the communication apparatus 200A first determines a time T5 (=T740−T730) that is a difference between times by using the first time-point information (T730) included in the second signal and the second time-point information (T740) obtained after decryption of the second signal. Further, the value of CF1 is subtracted from the time T5 to determine a time T6 (=T740−T730−CF1). Similarly, a time T7 (=T760−T750) that is a difference between times is determined by using the third time-point information (T750) included in the third signal and the fourth time-point information (T760) obtained after the communication apparatus 100 decrypts the third signal. Further, the value of CF2 is subtracted from the time T7 to determine a time T8 (=T760−T750−CF2). Note that the fourth time-point information is transmitted from the communication apparatus 100 to the communication apparatus 200A by the signal transmitted in Step S450, for example. As described in Expression 2 as follows, a time T9 obtained by subtracting the time T8 from the time T6 is determined.

$$T 9 = ( T 740 - T 730 - CF 1 ) - ( T 760 - T 750 - CF 2 ) \qquad ( Expression 2 )$$

The second PTP controller 240 determines a time T10 (=(T9)/2) that is half of T9. Note that the determination method described above is an example, and T6 may be determined first, or T6 and T8 may be determined simultaneously, when T9 is determined, which is performed by the second PTP controller 240 of the communication apparatus 200A. In addition, without obtaining the time T5 to the time T8, the six terms of Expression 2 may be appropriately interchanged in a range that does not affect the calculation result. In short, the second PTP controller 240 determines the time T10 by using the first time-point information to the fourth time-point information, the value of CF1, and the value of CF2.

The time T10 is a difference (deviation) of the time point of the communication apparatus 200A with respect to the communication apparatus 100. Thus, it is possible to perform time-point synchronization between the communication apparatus 100 and the communication apparatus 200A by correcting the time point of the communication apparatus 200A using the time T10. Note that this difference may also be referred to as Offset of slave.

Note that, in the communication apparatus 100, the predetermined values defined in the first process are the same value. For example, the predetermined values used in Steps S700A, S700B, 5700C, and S700D are the same value. Furthermore, in the communication apparatus 100, the predetermined values defined in the second process are the same value.

Note that, in the communication apparatus 200A, the predetermined values defined in the first process are the same value. Similarly, the predetermined values defined in the second process are the same value. For example, the predetermined values used in Steps S710A, S710B, S710C, and S710D are the same value.

Note that the predetermined value may be, for example, a predetermined value that is common to the first process and the second process, that is common for each communication apparatus, or the like.

Therefore, in each communication apparatus, when time-point information is attached to a corresponding signal in the first process and the second process, the time (for example, T731−T730) taken for the first process and the second process can be determined to be a predetermined first time and a predetermined second time, respectively, for each communication apparatus. Therefore, the time T1 and the time T3 can be set to predetermined times regardless of the time taken for the process of encrypting or decrypting the signal.

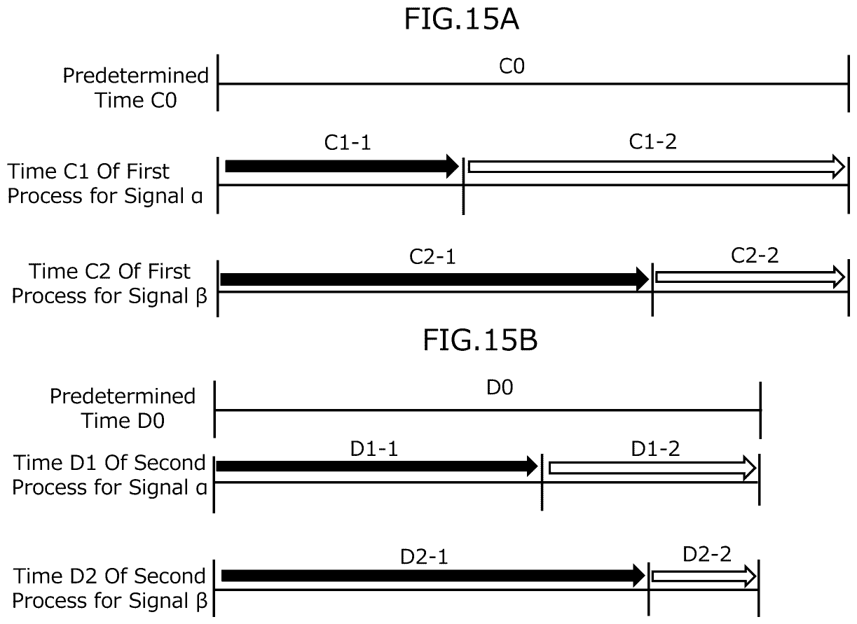

Here, the processing time in the first process and the second process will be described. FIGS. 15A and 15B are diagrams illustrating an example of a relationship among a predetermined time defined for each of the first process and the second process and a time of a process on a signal.

FIG. 15A is an example for describing a relationship among a defined predetermined time C0, a time C1 taken for the first process on a signal a, and a time C2 taken for the first process on a signal 3, in the first process. Note that FIG. 15A is applied to, for example, the communication apparatus 100 or the communication apparatus 200. Note that the signal a and the signal R are, for example, any two signals (for example, the signal processed in Step S700A and the signal processed in Step S700B) that are subjected to the first process in the communication apparatus 100.

The predetermined time C0 is, for example, a time corresponding to a predetermined value defined in FIG. 15. The time C1 of the first process on the first signal includes a time C1-1 and a time C1-2. The time C1-1 corresponds to a time taken to encrypt the signal a. In addition, the time C1-2 corresponds to a difference between the time C0 and the time C1-1.

In addition, the time C2 of the first process on the signal R includes a time C2-1 and a time C2-2. The time C2-1 corresponds to a time taken to encrypt the signal 3. In addition, the time C2-2 corresponds to a difference between the time C0 and the time C2-1.

The time for encrypting the signal may vary for each signal depending on, for example, the property of the signal. Therefore, by determining the predetermined time C0 corresponding to a predetermined value longer than the maximum time of the time taken for the encryption of the signal, it is possible to set a fixed processing time regardless of the encryption time for the signal. Specifically, the time C1-2 that is the standby time is provided after the time C1-1 such that the time C1 becomes the time C0. Similarly, the time C2-2 which is the standby time is provided after the time C2-1 such that the time C2 becomes the time C0. In this manner, the time C1 and the time C2 are unified to the time C0. In short, the time C1 and the time C2 are the same time. Note that the standby time in the time C1-2 and the time C2-2 is, for example, a time at which an encrypted signal is stored in the buffer unit 141-2.

FIG. 15B is an example for describing a relationship among a defined predetermined time D0, a time D1 taken for the second process on a signal a, and a time D2 taken for the second process on a signal 3, in the second process. Note that FIG. 15B is applied to, for example, the communication apparatus 100 or the communication apparatus 200A. Note that the signal a and the signal R are, for example, any two signals (for example, the signal processed in Step S710A and the signal processed in Step S710B) that are subjected to the second process in the communication apparatus 200.

The predetermined time D0 is, for example, a time corresponding to a predetermined value defined in FIG. 14. The time D1 of the first process on the signal a includes a time D1-1 and a time D1-2. The time D1-1 corresponds to a time taken to decrypt the signal a. In addition, the time D1-2 corresponds to a difference between the time D0 and the time D1-1.

Furthermore, the time D2 of the second process on the signal R includes a time D2-1 and a time D2-2. The time D2-1 corresponds to a time taken to decrypt the signal 3. In addition, the time D2-2 corresponds to a difference between the time D0 and the time D2-1.

The time for decryption of the signal may vary for each signal, for example, depending on the content of the signal or the like, or due to waiting by multiplexing processing of the signal to be decrypted. Therefore, by determining the predetermined time D0 corresponding to a predetermined value longer than the maximum time of the time taken for the decryption of the signal, it is possible to set a fixed processing time regardless of the decryption time for the signal. Specifically, the time D1-2 that is the standby time is provided after the time D1-1 such that the time D1 becomes the time D0. Similarly, the time D2-2 which is the standby time is provided after the time D2-1 such that the time D2 becomes the time D0. In this manner, the time D1 and the time D2 are unified to the time D0. In short, the time D1 and the time D2 are the same time. Note that the standby time in the time D1-2 and the time D2-2 is, for example, a time at which an encrypted signal is stored in the buffer unit 261-2.

As a result, the time taken for the first process on the signal a and the time taken for the first process on the signal R can be unified to a predetermined first time for each of the communication apparatus 100 and the communication apparatus 200.

Furthermore, similarly, the time taken for the second process on the signal a and the time taken for the second process on the signal R can be unified to a predetermined second time for each of the communication apparatus 100 and the communication apparatus 200.

Note that, even in a case where the synchronization process is repeatedly performed, since the first time and the second time are unified for each of the communication apparatus 100 and the communication apparatus 200, the time T6 and the time T8 are unified to a predetermined time.

Thus, in a case where the synchronization process is repeatedly performed, the time T9 and the time T10 can also be determined to be a fixed time, for example, regardless of the influence of the property of the signal or the like.

Thus, a difference (deviation) of the time point of the communication apparatus 200 with respect to the communication apparatus 100 can be set to a time corresponding to a predetermined value. For example, the time T10 can be made fixed. As a result, since the influence of the difference in processing time due to the encryption and decryption processes can be reduced, the fluctuation for each synchronization process is reduced, and it is possible to improve the synchronization precision.

Note that the predetermined time C0 and the predetermined time D0 may be equal. In short, for example, the first timer that is an example of the timer used by the master device (for example, the communication apparatus 100) in the first process including encryption may be different from the fourth timer that is an example of the timer used by the master device (for example, the communication apparatus 100) in the second process including decryption. Furthermore, for example, the third timer that is an example of the timer used by the slave device (for example, the communication apparatus 200) in the first process including encryption may be different from the second timer that is an example of the timer used by the slave device (for example, the communication apparatus 100) in the second process including decryption. Furthermore, for example, the predetermined time C0 may be the sum of the time C1-1 and the time C2-1. In that case, the time C1-2 and the time C2-1 are equal to each other. Furthermore, the predetermined time C0 may be set according to the cycle of the first signal, for example.

Note that C0 corresponds to, for example, a predetermined value corresponding to the first timer. Alternatively, C0 corresponds to, for example, a predetermined value corresponding to the third timer. In addition, D0 corresponds to, for example, a predetermined value corresponding to the second timer. Alternatively, D0 corresponds to, for example, a predetermined value corresponding to the fourth timer.

Furthermore, for example, the predetermined time D0 may be the sum of the time D1-1 and the time D2-1. In that case, the time D1-2 and the time D2-1 are equal to each other. Furthermore, the predetermined time D0 may be set according to the cycle of the first signal, for example.

Note that the predetermined value to be added to the value of the corresponding CF in the first process and the second process in the slave device that performs correction in the synchronization process, for example, in the communication apparatus 200A can be stored in the processor 260 or the like of the communication apparatus 200A in advance. By using the stored value together with the value of the CF corresponding to the case where the communication apparatus 200A performs the synchronization process, a process similar to the above synchronization process can be performed. In addition, with this configuration, in the communication apparatus 200A, the process of adding the predetermined value to the value of the CF can be omitted in the first process and the second process.

Note that, in the first process and the second process performed in each communication apparatus, regarding the value of the CF to be added to the corresponding signal, for example, the process of adding the time T7 that is the difference between the maximum time taken for encryption and the maximum time taken for decryption, to the longer process (for example, the first process in a case where the maximum time taken for encryption is longer) and adding the value to the CF in the shorter process (for example, the second process in a case where the maximum time taken for encryption is longer) can be omitted. Since the time commonly taken for encryption and decryption can be regarded as the time taken for the communication path, the time T9 can be similarly determined and synchronization can be performed.

Note that information including the time T7 on the master device side may be transmitted to the slave device side by a process different from the synchronization process. In this case, the process of adding the value to the CF can be omitted in the first process and the second process in the master device. By combining the time T7 on the master device side and the time T7 on the slave device side to perform the process on the slave device side, the time T9 can be determined in the similar manner as described above, and synchronization can be performed.

As described above, in the second embodiment, in the communication apparatus 100 and the communication apparatus 200, the times taken for the first process and the second process can be made fixed for each of the communication apparatus 100 and the communication apparatus 200. Therefore, it is possible to reduce the influence of a difference in processing time due to the encryption and decryption processes. For example, in the communication apparatus 100 and the communication apparatus 200A, since the times taken for the first process and the second process are the same for each of the communication apparatus 100 and the communication apparatus 200A, it is possible to prevent deterioration in synchronization precision due to the encryption and decryption processes for a packet, and it is possible to improve the synchronization precision.

In addition, even in a case where the time of the first process and the time of the second process in one communication apparatus are different, by adding a predetermined value to the CF, a synchronous calculation process including the encryption processing time and the decryption processing time can be performed. Therefore, it is possible to prevent the deterioration in synchronization precision due to the encryption and decryption processes.

Note that the communication apparatus 100 and the communication apparatus 200 identify a first packet that is a PTP packet and a second packet that is a packet other than the PTP packet. In addition, as a method of identification, for example, a MAC address is used for allocation. In the case of the first packet, the communication apparatus 100 and the communication apparatus 200 may perform a process having the contents described in the first embodiment. Furthermore, in the case of the second packet, the communication apparatus 100 and the communication apparatus 200 may perform control so as not to perform time adjustment. In this manner, since a time matching process can be omitted for the second packet, it is possible to accelerate a process for the second packet.

Note that, at the time of transmission, a transmission timing of the first packet needs to be strictly observed. This is to prevent an occurrence of a situation in which the second packet is transmitted at the transmission timing of the first packet because the transmission timing of the first packet is known in advance. In short, when the transmission timing of the first packet is approached, control may be performed such that only a packet that does not overlap the transmission timing of the first packet passes in accordance with the packet length of the second packet. Note that, when the transmission timing of the first packet arrives, the first packet is transmitted, and then the second packet is caused to pass through until the transmission timing of the next first packet comes close.

### Third Embodiment

In the first embodiment, an example in which the times taken for the first process and the second process can be made fixed for each of the communication apparatus 100 and the communication apparatus 200 when the time-point information corresponding to the signal is controlled in the synchronization process has been described. In the second embodiment, an example in which, when time-point information corresponding to a signal is controlled for each of a communication apparatus 100 and a communication apparatus 200, the time taken for the first process and the time taken for the second process are fixed times has been described. In a third embodiment, an example in which an encryption/decryption processor is configured separately from a processor will be described. Note that a communication system 1 in the third embodiment is similar to those in the first embodiment and the second embodiment, and therefore the description thereof will be omitted.

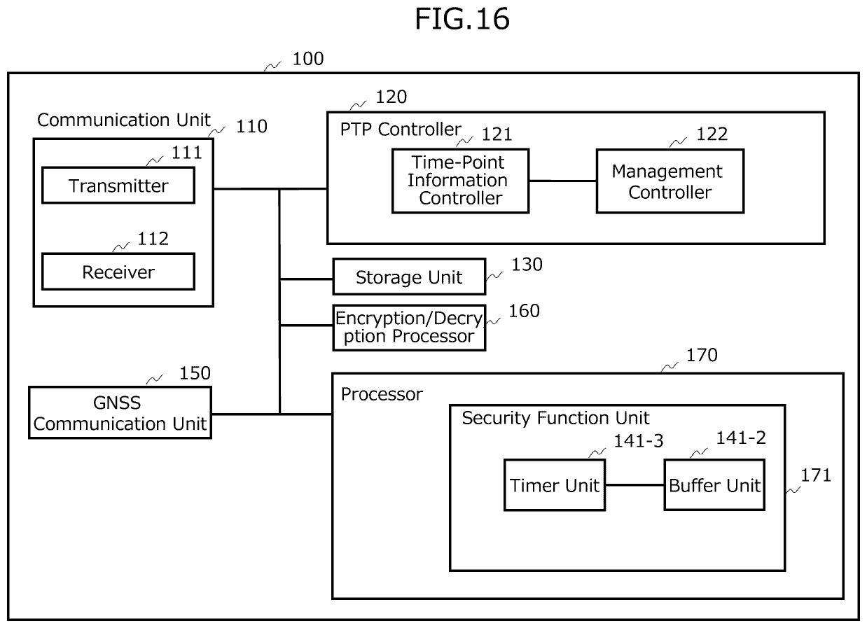

A communication apparatus 100 in the third embodiment will be described. FIG. 16 is a diagram illustrating an example of a functional configuration diagram of the communication apparatus 100. Note that the same components as those in FIG. 2 are denoted by the same reference signs, and the description thereof will be omitted.

An encryption/decryption processor 160 of the communication apparatus 100 has a configuration similar to that of the encryption/decryption processor 141-1 illustrated in FIG. 2. Note that a processor 170 includes a security function unit 171. In addition, the security function unit 171 includes a buffer unit 141-2 and a timer unit 141-3. In short, the security function unit 171 does not include the function of the encryption/decryption processor 141-1 included in the security function unit 141 illustrated in FIG. 2.

Therefore, for example, when a signal is input to the processor 170, the signal is transferred from the processor 170 to the encryption/decryption processor 160. After the encryption/decryption processor 160 has completed the encryption or decryption process, the processor 170 receives the encrypted or decrypted signal from the encryption/decryption processor 160 and stores the received signal in the buffer unit 141-2. The signal stored in the buffer unit 141-2 is output to the communication unit 110 according to the value of a timer managed by the timer unit 141-3. In this manner, the encryption/decryption processor 160 has a configuration of a processor that performs the encryption/decryption process of the first signal, the second signal, the third signal, and the fourth signal in common. Note that the timer unit 141-3 starts the timer, for example, at a timing at which a signal is transferred from the processor 170 to the encryption/decryption processor 160.

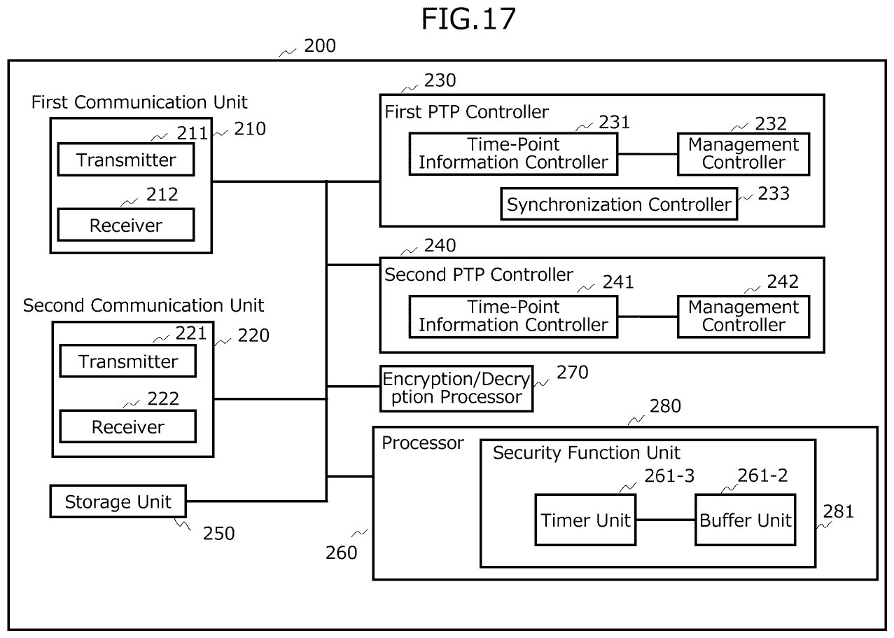

Next, a communication apparatus 200 in the third embodiment will be described. FIG. 17 is a diagram illustrating an example of a functional configuration diagram of the communication apparatus 200. Note that the same components as those in FIG. 3 are denoted by the same reference signs, and the description thereof will be omitted.

An encryption/decryption processor 270 of the communication apparatus 200 has a configuration similar to that of the encryption/decryption processor 261-1 illustrated in FIG. 3.

In addition, a processor 280 includes a security function unit 281. In addition, the security function unit 281 includes a buffer unit 261-2 and a timer unit 261-3. In short, the security function unit 281 does not include the function of the encryption/decryption processor 261-1 included in the security function unit 261 illustrated in FIG. 3.

Therefore, for example, when a signal is input to the processor 280, the signal is transferred from the processor 280 to the encryption/decryption processor 270. After the encryption/decryption processor 270 has completed the encryption or decryption process, the processor 280 receives the encrypted or decrypted signal from the encryption/decryption processor 270 and stores the received signal in the buffer unit 261-2. The signal stored in the buffer unit 261-2 is output to a second communication unit 220 according to the value of a timer managed by the timer unit 261-3. Note that the timer unit 261-3 starts the timer, for example, at a timing at which a signal is transferred from the processor 280 to the encryption/decryption processor 270.

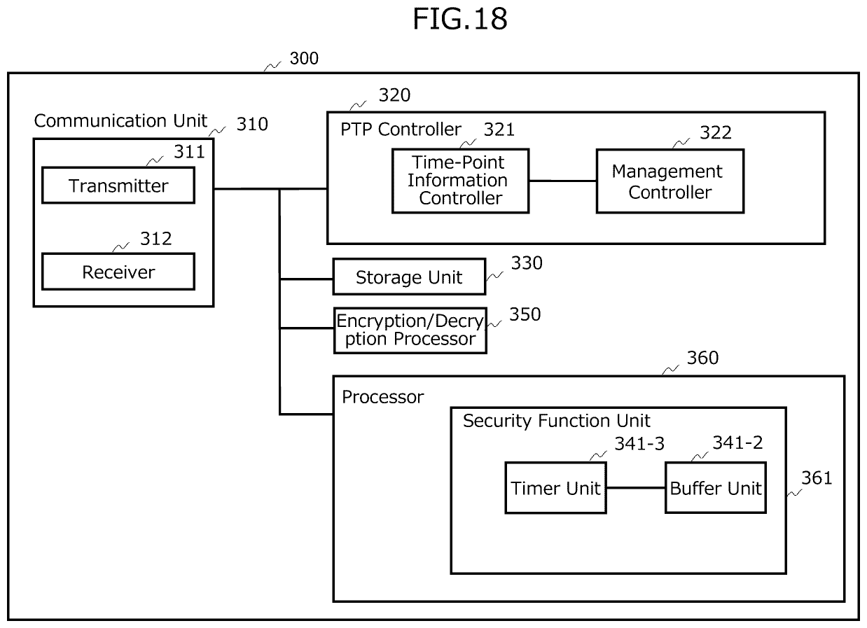

Next, a communication apparatus 300 in the third embodiment will be described. FIG. 18 is a diagram illustrating an example of a functional configuration diagram of the communication apparatus 300. Note that the same components as those in FIG. 4 are denoted by the same reference signs, and the description thereof will be omitted.

An encryption/decryption processor 350 of the communication apparatus 300 has a configuration similar to that of the encryption/decryption processor 341-1 illustrated in FIG. 4.

In addition, a processor 360 includes a security function unit 361. In addition, the security function unit 361 includes a buffer unit 341-2 and a timer unit 341-3. In short, the security function unit 361 does not include the function of the encryption/decryption processor 341-1 included in the security function unit 341 illustrated in FIG. 4.

Therefore, for example, when a signal is input to the processor 360, the signal is transferred from the processor 360 to the encryption/decryption processor 350. After the encryption/decryption processor 350 has completed the encryption or decryption process, the processor 360 receives the encrypted or decrypted signal from the encryption/decryption processor 350 and stores the received signal in the buffer unit 341-2. The signal stored in the buffer unit 341-2 is output to a communication unit 310 according to the value of a timer managed by the timer unit 341-3. Note that the timer unit 341-3 starts the timer, for example, at a timing at which a signal is transferred from the processor 360 to the encryption/decryption processor 350.

Note that, in the third embodiment, processing in the communication system 1 is similar to the contents described in the first embodiment, and thus the description thereof will be omitted.

As described above, in the third embodiment, in the communication apparatus 100 and the communication apparatus 200, the times taken for the first process and the second process can be made fixed for each of the communication apparatus 100 and the communication apparatus 200. Therefore, since the influence of the difference in processing time due to the encryption and decryption processes can be reduced, it is possible to secure the synchronization precision. For example, since the times taken for the first process and the second process are the same, it is possible to prevent deterioration in synchronization precision due to encryption and decryption processes for a packet. Therefore, even though the synchronization process is repeatedly performed, the fluctuation for each synchronization process is reduced, and thus it is possible to maintain the synchronization precision.

Note that the addition processor 142 described in the second embodiment may be added to the processor 170 of the communication apparatus 100 illustrated in FIG. 16. Similarly, the addition processor 262 described in the second embodiment may be added to the processor 280 of the communication apparatus 200 illustrated in FIG. 17. Similarly, the addition processor 342 described in the second embodiment may be added to the processor 360 of the communication apparatus 300 illustrated in FIG. 18. In this manner, the operation described in the second embodiment can be performed.

### Hardware Configuration of Each Device in Each Embodiment

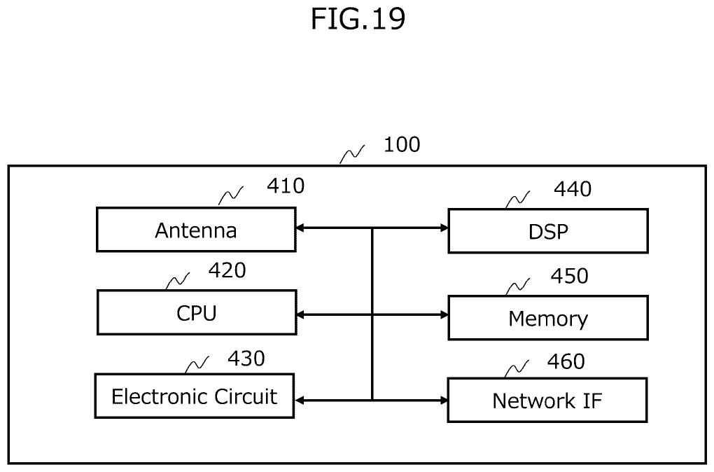

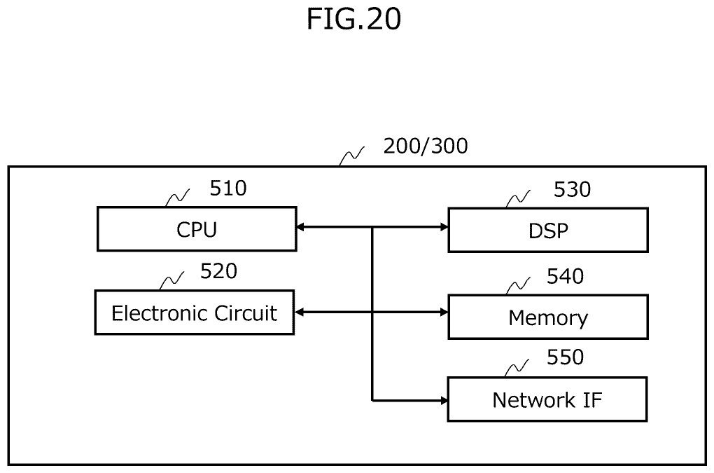

A hardware configuration of each device in the communication system 1 in each embodiment will be described with reference to FIGS. 19 and 20.

FIG. 19 is a diagram illustrating an example of a hardware configuration of the communication apparatus 100. As illustrated in FIG. 19, the communication apparatus 100 includes, for example, an antenna 410, a central processing unit (CPU) 420, an electronic circuit 430, a digital signal processor (DSP) 440, a memory 450, and a network interface (IF) 460, as hardware components. Note that the components are connected via a bus so as to be able to input and output various signals and data signals. In addition, examples of the electronic circuit 430 include an application specific integrated circuit (ASIC), a field-programming gate array (FPGA), and a large scale integration (LSI). The memory 450 includes, for example, at least one of a random access memory (RAM) such as a synchronous dynamic random access memory (SDRAM), a read only memory (ROM), and a flash memory, and stores a program, control information, and a data signal.

The correspondence between the functional configuration of the communication apparatus 100 illustrated in FIGS. 2, 9, and 16 and the hardware configuration will be described. The PTP controller 120, the processor 140, the encryption/decryption processor 160, and the processor 170 are realized by, for example, the CPU 420, the electronic circuit 430, the DSP 440, the memory 450, and the like. Furthermore, the storage unit 130 is implemented by, for example, the memory 450. Furthermore, the communication unit 110 is implemented by, for example, the network IF 460. The GNSS communication unit 150 is implemented by, for example, the antenna 410.

FIG. 20 is a diagram illustrating an example of a hardware configuration of the communication apparatus 200 and the communication apparatus 300. As illustrated in FIG. 20, the communication apparatus 200 and the communication apparatus 300 include, for example, a central processing unit (CPU) 510, an electronic circuit 520, a digital signal processor (DSP) 530, a memory 540, and a network interface (IF) 550, as hardware components. Note that the components are connected via a bus so as to be able to input and output various signals and data signals. In addition, examples of the electronic circuit 520 include an application specific integrated circuit (ASIC), a field-programming gate array (FPGA), and a large scale integration (LSI). The memory 540 includes, for example, at least one of a random access memory (RAM) such as a synchronous dynamic random access memory (SDRAM), a read only memory (ROM), and a flash memory, and stores a program, control information, and a data signal. Furthermore, for example, in a case where the communication apparatus 300 performs radio communication with a terminal device, the communication apparatus 200 may include an antenna (not illustrated).

The correspondence between the functional configuration of the communication apparatus 200 illustrated in FIGS. 3, 10, and 17 and the hardware configuration will be described. The first PTP controller 230, the second PTP controller 240, the processor 260, the encryption/decryption processor 270, and the processor 280 are implemented by, for example, the CPU 510, the electronic circuit 520, the DSP 530, the memory 540, and the like. Furthermore, the storage unit 250 is implemented by, for example, the memory 540. Furthermore, the first communication unit 210 and the second communication unit 220 are implemented by, for example, the network IF 550. Note that the first communication unit 210 and the second communication unit 220 are implemented by different network IFs 550.

The correspondence between the functional configuration of the communication apparatus 300 illustrated in FIGS. 4, 11, and 18 and the hardware configuration will be described. The PTP controller 320, the processor 340, the encryption/decryption processor 350, and the processor 360 are realized by, for example, the CPU 510, the electronic circuit 520, the DSP 530, the memory 540, and the like. Furthermore, the storage unit 330 is implemented by, for example, the memory 540. Furthermore, the communication unit 310 is implemented by, for example, the network IF 550.

In a communication apparatus having a synchronization system such as the PTP, the synchronization precision can be secured even though packets are encrypted and decrypted.

Throughout the descriptions, the indefinite article “a” or “an”, or adjective “one” does not exclude a plurality.

All examples and conditional language recited herein are intended for the pedagogical purposes of aiding the reader in understanding the disclosure and the concepts contributed by the inventor to further the art, and are not to be construed limitations to such specifically recited examples and conditions, nor does the organization of such examples in the specification relate to a showing of the superiority and inferiority of the disclosure. Although one or more embodiments of the present disclosures have been described in detail, it should be understood that the various changes, substitutions, and alterations could be made hereto without departing from the spirit and scope of the disclosure.

What is claimed is:

1. A communication system comprising:
a first communication apparatus; and
a second communication apparatus that performs a synchronization process for establishing synchronization with the first communication apparatus, wherein
the first communication apparatus is configured to
perform a first process including encryption on a first signal to which information regarding a first time point is attached, and start a first timer with the first process, and
transmit an encrypted first signal in response to expiration of the first timer,
the second communication apparatus is configured to
receive the encrypted first signal from the first communication apparatus, and start a second timer with a second process including decryption on the first signal,
enable control for obtaining second time-point information in response to expiration of the second timer,
obtain information regarding a third time point, perform the first process on a second signal, and start third timer with the first process, and
transmit an encrypted second signal in response to expiration of the third timer,
the first communication apparatus is configured to
receive the encrypted second signal from the second communication apparatus, perform the second process on the second signal, start a fourth timer with the second process, and enable control for obtaining fourth time-point information in response to expiration of the fourth timer,
a time of the first timer corresponds to a first time longer than a time taken for a process for encryption in the first communication apparatus,
a time of the second timer corresponds to a second time longer than a time taken for a process for the decryption in the second communication apparatus,
a time of the third timer corresponds to a third time longer than a time taken for a process for the encryption in the second communication apparatus, and
a time of the fourth timer corresponds to a fourth time longer than a time taken for a process for decryption in the first communication apparatus.

2. The communication system according to claim 1, wherein
the first communication apparatus transmits the fourth time-point information to the second communication apparatus.

3. The communication system according to claim 1, wherein
the information regarding the first time point, information regarding a second time point, the information regarding the third time point, and information regarding a fourth time point are pieces of information of time points used by the second communication apparatus to establish synchronization with the first communication apparatus.

4. The communication system according to claim 1, wherein
the first time and the fourth time are the same time, and
the second time and the third time are the same time.

5. The communication system according to claim 1, wherein
the second communication apparatus performs the synchronization process by using information corresponding to a time of a difference between the first time and the fourth time included in the first signal.

6. The communication system according to claim 1, wherein
the first signal is a Sync Message, and
the second signal is Delay_Req Message.

7. The communication system according to claim 1, wherein
the first time is a time longer than a maximum time among times of different encryption processes, according to a signal, and
the fourth time is a time longer than a maximum time among times of different decryption processes, according to a signal.

8. The communication system according to claim 6, wherein
the first communication apparatus
performs a process of adding the first time to a first correction field of the first signal before encryption of the first signal, and
performs a process of adding the fourth time to a second correction field of a decrypted second signal.

9. The communication system according to claim 6, wherein
the second communication apparatus
performs a process of adding the second time to a first correction field of a decrypted first signal, and
performs a process of adding the third time to a second correction field of the second signal before encryption of the second signal.

10. The communication system according to claim 6, wherein
the first communication apparatus
performs a process of adding time of ½ of a difference between the first time and the fourth time to a first correction field of the first signal before encryption of the first signal, and
performs a process of adding a negative sign to the time of ½ of the difference between the first time and the fourth time, and adding a result of the addition to a second correction field of a decrypted second signal.

11. The communication system according to claim 6, wherein
the second communication apparatus
performs a process of adding time of ½ of a difference between the second time and the third time to a first correction field of a decrypted first signal, and
performs a process of adding a negative sign to the time of ½ of the difference between the second time and the third time, and adding a result of the addition to a second correction field of the second signal before the encryption of the second signal.

12. A communication apparatus comprising:
processor circuitry configured to perform a first process including encryption on a first signal to which information regarding a first time is attached, and enable starting of a first timer with the first process;
a transmitter configured to transmit an encrypted first signal to a second communication apparatus in response to expiration of the first timer; and
a receiver configured to receive an encrypted second signal from the second communication apparatus, wherein
the processor circuitry is configured to perform a second process on the second signal, control a fourth timer to start with the second process, and enable control for obtaining fourth time-point information in response to expiration of the fourth timer,
a time of the first timer is a first time longer than a time taken for a process of the encryption in a first communication apparatus, and
a time of the fourth timer is a second time longer than a time taken for a process of decryption in the first communication apparatus.

13. A communication apparatus comprising:
a receiver;
processor circuitry; and
a transmitter, wherein
the communication apparatus performs a synchronization process for synchronizing with a first communication apparatus,
the receiver is configured to receive an encrypted first signal from the first communication apparatus;
the processor circuitry is configured to perform a second process including decryption on the first signal, start a second timer with the second process, enable obtaining of second time-point information in response to expiration of the second timer, obtain information regarding a third time point, perform a first process including encryption on a second signal, and enable control to start a third timer with the first process; and
the transmitter is configured to transmit an encrypted second signal in response to expiration of the third timer.
